(19) United States
(12) Patent Application Publication
(10) Pub. No.: US 2026/0290173 A1
(43) Pub. Date: Sep. 24, 2026

(54) ROUTE GENERATION DEVICE, ROUTE GENERATION METHOD, AND RECORDING MEDIUM

(71) Applicant: NEC Corporation, Tokyo (JP)

(72) Inventors: Remi TANAKA, Tokyo (JP); Takeshi Shouta, Tokyo (JP); Hiroyuki Kakinuma, Tokyo (JP); Tomoyuki Muto, Tokyo (JP)

(73) Assignee: NEC Corporation, Tokyo (JP)

(21) Appl. No.: 19/696,426

(22) Filed: Jun. 3, 2026

Related U.S. Application Data
(63) Continuation of application No. 18/714,206, filed on Dec. 16, 2021.

(51) Int. Cl. G08G 5/32

(52) U.S. Cl. CPC G08G 5/32

(57) ABSTRACT

To enable a route that satisfies a request of a user who operates an unmanned aerial vehicle to be presented in a style according to a predetermined format, the present invention involves: acquiring departure location information indicating the departure location of an unmanned aerial vehicle and destination location information indicating the destination location thereof; generating a plurality of candidate routes from the departure location to destination location of the unmanned aerial vehicle; executing processing for outputting route information indicating candidate routes that satisfy a predetermined condition among the plurality of generated candidate routes; and outputting the route information in a style that enables output of the routes, which are indicated by the candidate routes that satisfy the predetermined condition, according to the predetermined format.

This application is a continuation application of United States Patent Application Ser. No. 18/714,206 filed on May 29, 2024, which is a National Stage Entry of PCT/JP2021/046455 filed on December 16, 2021, the contents of all of which are incorporated herein by reference, in their entirety.

### TECHNICAL FIELD

The present invention relates to a route generation device, a route generation method, and a recording medium.

### BACKGROUND ART

In recent years, there has been an increasing demand for the operation of drones that fly in the air in an unmanned manner. In addition, when flying the drone, it may be necessary to submit a flight plan corresponding to the contents of the flight to a regional civil aviation bureaus or an airport administrative office.

PTL 1 describes that a server generates data of a new route when the current route is not appropriate, and the server transmits a flight control instruction for automatically controlling the air mobile in such a way that the air mobile flies on the new route.

PTL 2 describes that a control device receives information regarding a departure location and a destination location from an unmanned aerial vehicle and sets a flight route. In addition, PTL 2 describes that a control device sets a flight path configuring a flight route with reference to a distance, a flight prohibited area, and other weather information.

PTL 3 describes that a navigation system determines a route of an unmanned aerial vehicle to a desired destination location.

### Citation List

### Patent Literature

PTL 1: JP 2020-205103 A

PTL 2: JP 2020-4200 A

PTL 3: JP 2020-513122 A

### SUMMARY OF INVENTION

### Technical Problem

In the methods described in PTL 1 to PTL 3, one route is determined in accordance with preset settings, but a route that satisfies a request of a user who operates a drone is not necessarily generated. Therefore, in the methods described in PTL 1 to PTL 3, a route corresponding to a request of a user who operates a drone is not necessarily generated. Therefore, the user who operates the drone needs to consider a route corresponding to the request and further create a flight plan in a format according to a predetermined format.

In view of the problems described above, an object of the present invention is to provide a route generation device, a route generation method, and a recording medium capable of presenting a route corresponding to a request of a user who operates an unmanned aerial vehicle in a format according to a predetermined format.

### Solution to Problem

According to one aspect of the present invention, a route generation device comprises an acquisition means that acquires departure location information indicating a departure location and destination location information indicating a destination location of an unmanned aerial vehicle; a route generation means that generates a plurality of candidate routes from the departure location to the destination location of the unmanned aerial vehicle; and a processing means that performs processes for outputting route information indicating candidate routes that satisfy a predetermined condition among the plurality of generated candidate routes, wherein the processing means outputs the route information in a format capable of outputting the route, which is indicated by the candidate routes satisfying the predetermined condition, according to a predetermined format.

Furthermore, according to another aspect of the present invention, a route generation method comprises acquiring departure location information indicating a departure location and destination location information indicating a destination location of an unmanned aerial vehicle; generating a plurality of candidate routes from the departure location to the destination location of the unmanned aerial vehicle; performing processes for outputting route information indicating candidate routes that satisfy a predetermined condition among the plurality of generated candidate routes; and outputting the route information in a format capable of outputting the route, which is indicated by the candidate routes satisfying the predetermined condition, according to a predetermined format.

In addition, according to another further aspect of the present invention, a computer readable recording medium recorded with a route generation program that causes a computer to implement an acquisition function of acquiring departure location information indicating a departure location and destination location information indicating a destination location of an unmanned aerial vehicle; a route generation function of generating a plurality of candidate routes from the departure location to the destination location of the unmanned aerial vehicle; and a processing function of performing processes for outputting route information indicating candidate routes that satisfy a predetermined condition among the plurality of generated candidate routes, wherein the processing function outputs the route information in a format capable of outputting the route, which is indicated by the candidate routes satisfying the predetermined condition, according to a predetermined format.

### Advantageous Effects of Invention

According to a route generation device, a route generation method, and a recording medium of the present invention, it is possible to present a route corresponding to a request of a user who operates an unmanned aerial vehicle in a format according to a predetermined format.

### BRIEF DESCRIPTION OF DRAWINGS

FIG. 1 is a block diagram illustrating a configuration example of a route generation device according to a first example embodiment of the present invention.

FIG. 2 is a flowchart illustrating an operation example of a route generation device according to the first example embodiment of the present invention.

FIG. 3 is a block diagram illustrating a configuration example of a route generation system according to the second example embodiment of the present invention.

FIG. 4 is a block diagram illustrating a configuration example of a route generation device according to the second example embodiment of the present invention.

FIG. 5 is a schematic view schematically illustrating a corridor according to the second example embodiment of the present invention.

FIG. 6 is a diagram illustrating an example of corridor information stored in an area information storage unit of a route generation device according to the second example embodiment of the present invention.

FIG. 7 is an example of a case where route information generated in a format that can be output according to a predetermined format is output in the second example embodiment of the present invention.

FIG. 8 is an example of a case where route information generated in a format that can be output according to a predetermined format is output in the second example embodiment of the present invention.

FIG. 9 is an example of a case where route information generated in a format that can be output according to a predetermined format is output in the second example embodiment of the present invention.

FIG. 10 is a sequence diagram illustrating an operation example of a route generation system according to the second exemplary example embodiment of the present invention.

FIG. 11 is a flowchart illustrating an operation example of a route generation device according to the second example embodiment of the present invention.

FIG. 12 is a diagram illustrating a hardware configuration example of each example embodiment in the present invention.

### EXAMPLE EMBODIMENT

### First example embodiment

A first example embodiment of the present invention will be described.

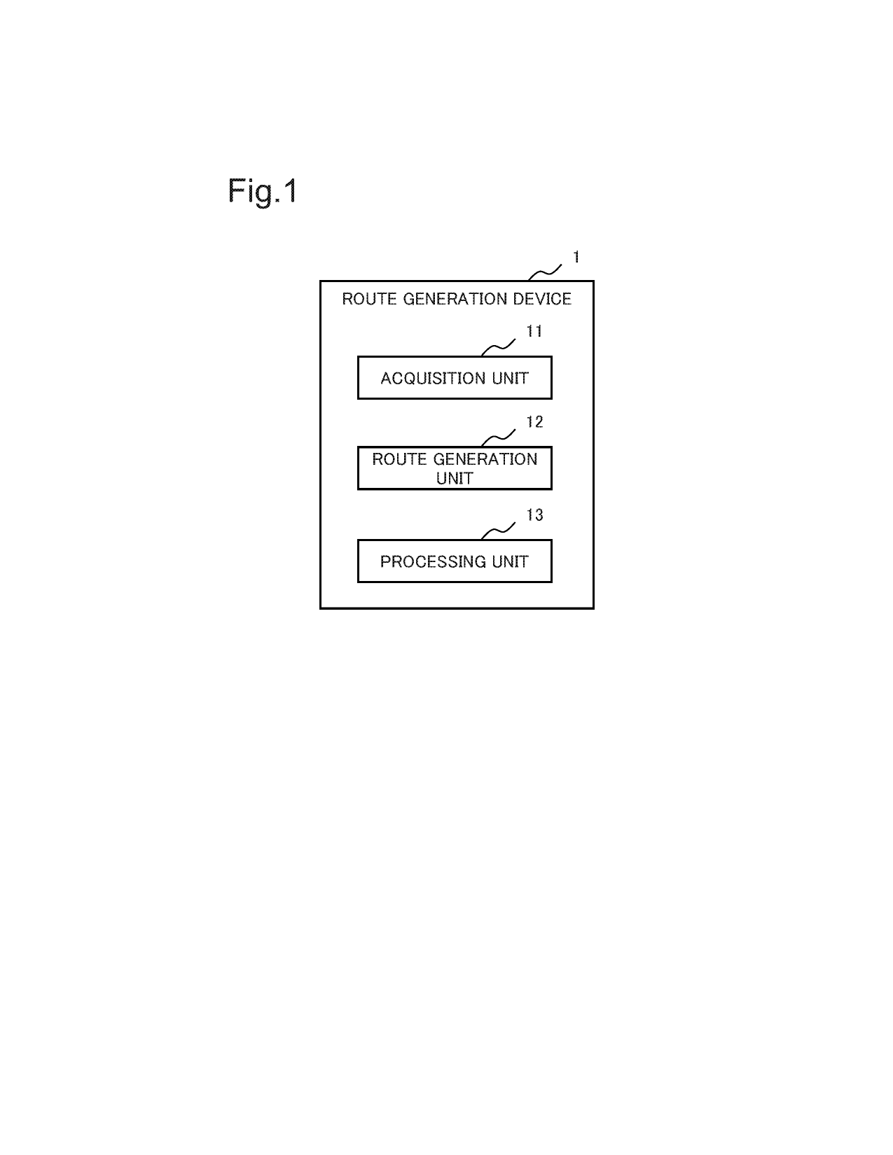

FIG. 1 is a block diagram illustrating a configuration example of a route generation device 1 of the present example embodiment.

The route generation device 1 of the present example embodiment includes an acquisition unit 11, a route generation unit 12, and a processing unit 13.

The acquisition unit 11 is an example of an acquisition means. The acquisition unit 11 acquires departure location information indicating a departure location and destination location information indicating a destination location of an unmanned aerial vehicle (not illustrated). For example, the acquisition unit 11 acquires the departure location information and the destination location information by receiving the departure location information and the destination location information from a processing device (not illustrated).

The acquisition source of the departure location information and the destination location information is, for example, a generation source or a transmission source of the departure location information and the destination location information. The processing device (not illustrated) is an example of an acquisition source of the acquisition unit 11. Specifically, the processing device is an information processing device used by the owner of the unmanned aerial vehicle, or an information processing device used by an individual or a company who uses the unmanned aerial vehicle. The processing device may be a database. The unmanned aerial vehicle is, for example, a drone.

The route generation unit 12 is an example of a route generation means. The route generation unit 12 generates a plurality of candidate routes from a departure location to a destination location of the unmanned aerial vehicle.

The route generation unit 12 uses the following parameters when generating a candidate route of the unmanned aerial vehicle. The route generation unit 12 uses at least one of a parameter related to weather, a parameter related to flight ability of the unmanned aerial vehicle, a parameter related to a flight plan of another unmanned aerial vehicle, and a parameter related to a cargo transported by the unmanned aerial vehicle. The route generation unit 12 may calculate, determine, or estimate a candidate route using the parameter. Since the parameter affects, for example, the flight speed or the flight time of the unmanned aerial vehicle, the parameter is used for generating the candidate route.

The processing unit 13 is an example of a processing means. The processing unit 13 performs a process for outputting route information indicating a candidate route that satisfies a predetermined condition among a plurality of candidate routes generated by the route generation unit 12. The processing unit 13 outputs the route information in a format capable of outputting the route indicated by the candidate route satisfying the predetermined condition according to a predetermined format. The processing unit 13 outputs one or a plurality or two or more pieces of route information.

For example, the processing unit 13 performs a process for transmitting route information in a format that can be output according to a predetermined format to a processing device that is an acquisition source of the departure location information and the destination location information. As a result, the processing device that is the acquisition source of the departure location information and the destination location information can output the route to the output device according to a predetermined format and present the route to the user. The processing device can cause a predetermined display device (not illustrated) to present one or a plurality or two or more routes corresponding to a request of a user who operates the unmanned aerial vehicle.

The processing unit 13 can output route information in a format that can be output according to a predetermined format to a communication interface (not illustrated), and can transmit the route information to a predetermined communication destination via the communication interface. The communication destination may be set in advance. The communication destination may be set based on an operation of an input/output interface (not illustrated) of the user.

The conditions to be satisfied by the candidate route include the following examples. For example, the condition is a condition related to time that it is a route in which the destination location is arrived the earliest. In addition, the condition is a condition related to the flight distance that it is a route in which the flight distance is the shortest. In addition, the condition is a condition related to the charge amount of the unmanned aerial vehicle that it is a route in which the power consumption is the lowest. Furthermore, the condition is a condition related to a fee that the fee required to arrive at the destination location is equal to or less than the upper limit or the lowest fee. Furthermore, for example, the condition may include a range such that the flight distance is equal to or greater than 500 m and less than 1 km. The conditions may include conditions other than those described above, or a plurality of conditions may be combined.

As described above, the route generation device 1 acquires the departure location information indicating the departure location of the unmanned aerial vehicle and the destination location information indicating the destination location, and generates a plurality of candidate routes from the departure location to the destination location of the unmanned aerial vehicle. The route generation device 1 performs a process for outputting route information indicating a candidate route that satisfies a predetermined condition among a plurality of generated candidate routes. The route generation device 1 outputs route information in a format capable of outputting a route indicated by a candidate route satisfying a predetermined condition according to a predetermined format. The route generation device 1 outputs the route information in a format capable of outputting the route indicated by the candidate route satisfying the predetermined condition according to a predetermined format, in such a way that the route corresponding to the request of the user operating the unmanned aerial vehicle can be presented in a format according to the predetermined format.

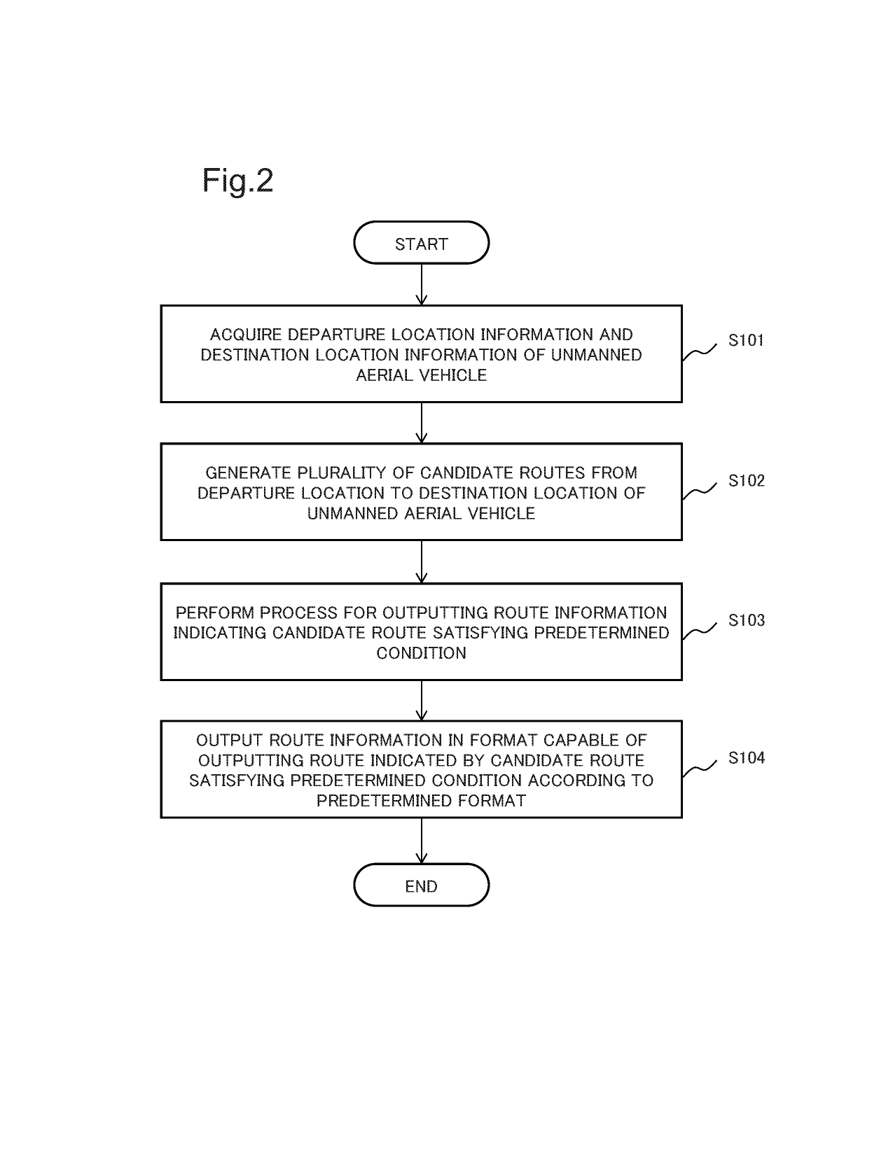

Next, an operation example of the route generation device 1 of the present example embodiment will be described with reference to FIG. 2. FIG. 2 is a flowchart illustrating an operation example of the route generation device 1.

The acquisition unit 11 acquires departure location information indicating a departure location and destination location information indicating a destination location of an unmanned aerial vehicle (step S101).

The route generation unit 12 generates a plurality of candidate routes from a departure location to a destination location of the unmanned aerial vehicle (step S102).

The processing unit 13 performs a process for outputting route information indicating a candidate route that satisfies a predetermined condition among the plurality of candidate routes generated in step S102 (step S103).

The processing unit 13 outputs the route information in a format capable of outputting the route indicated by the candidate route satisfying the predetermined condition according to a predetermined format (step S104).

As described above, the route generation device 1 outputs the route information in a format capable of outputting the route indicated by the candidate route satisfying a predetermined condition according to a predetermined format, in such a way that a route corresponding to the request of the user operating the unmanned aerial vehicle can be presented in the format according to the predetermined format.

### Second example embodiment

Next, a route generation device 2 according to a second example embodiment of the present invention will be specifically described.

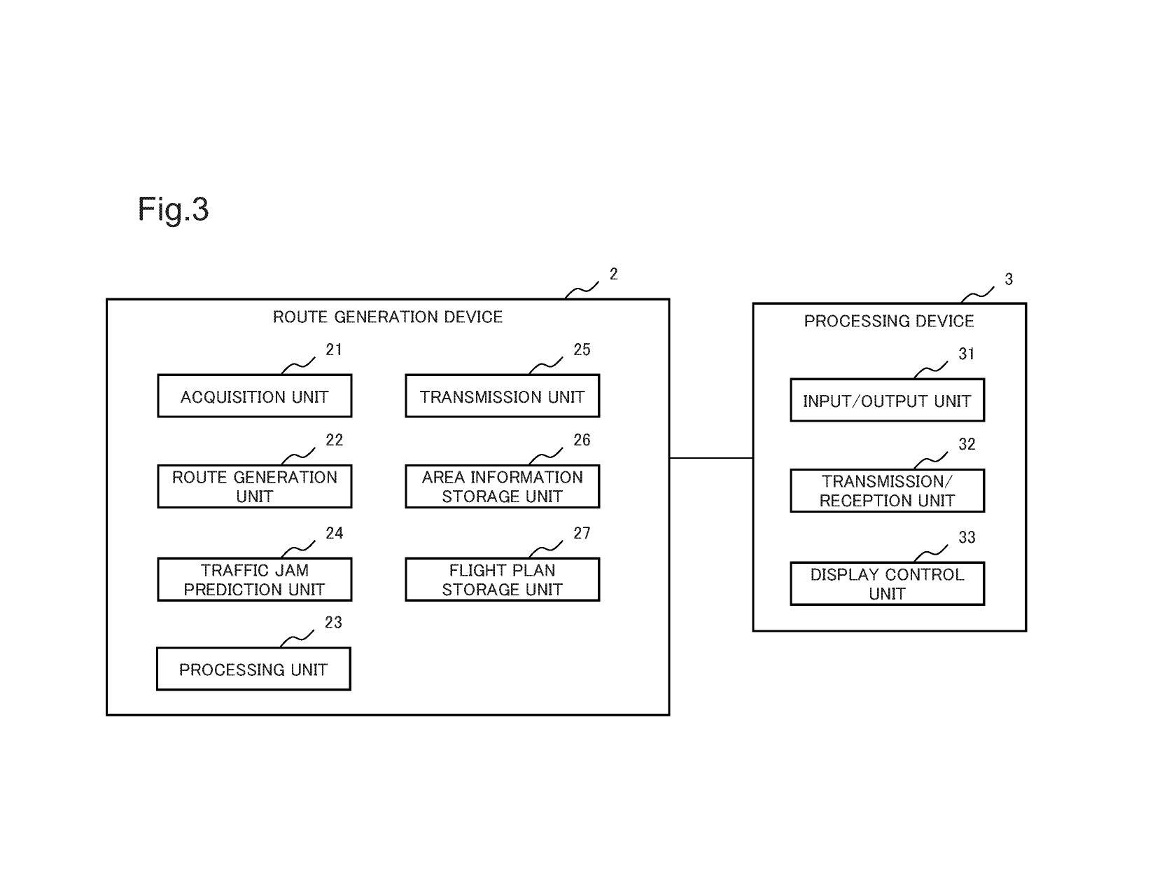

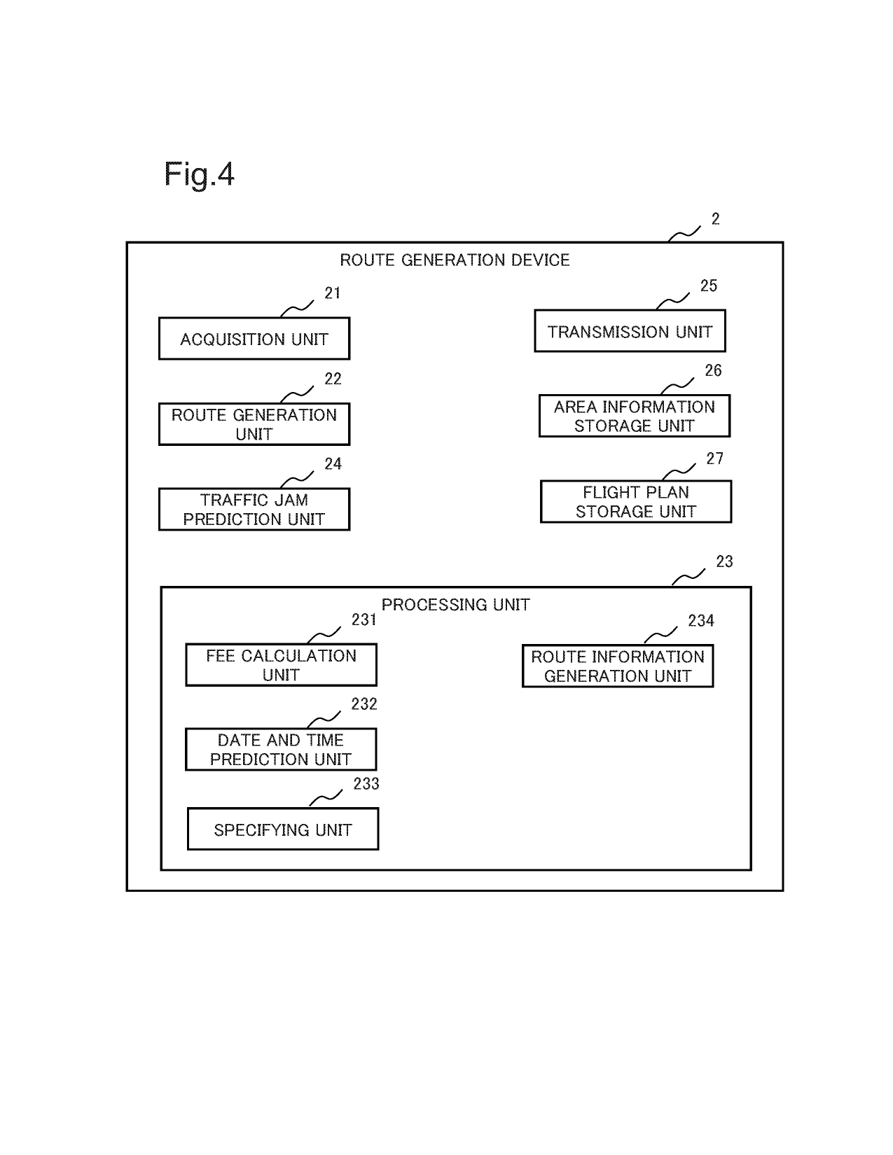

FIG. 3 is a block diagram illustrating a configuration example of a route generation system according to a second example embodiment of the present invention. FIG. 4 is a block diagram illustrating a configuration example of a route generation device 2 of the present example embodiment. In the second example embodiment, the route generation device 2 basically includes the configuration and function of the route generation device 1 of the first example embodiment.

As illustrated in FIG. 3, the route generation system includes a route generation device 2 and a processing device 3.

The configuration of the route generation device 2 of the present example embodiment will be described in detail with reference to FIGS. 3 and 4. The route generation device 2 of the present example embodiment includes an acquisition unit 21, a route generation unit 22, and a processing unit 23. A traffic jam prediction unit 24 receives an input from at least the route generation unit 22. A transmission unit 25 receives an input from at least the processing unit 23. An area information storage unit 26 and a flight plan storage unit 27 will be described later.

The acquisition unit 21 receives, from the processing device 3, departure location information indicating a departure location of an unmanned aerial vehicle (not illustrated), departure date and time information indicating a departure date and time of the unmanned aerial vehicle, and destination location information indicating a destination location, thereby acquiring the departure location information, the departure date and time information, and the destination location information. The acquisition unit 21 outputs the departure location information, the departure date and time information, and the destination location information to the route generation unit 22 in association with each other.

The acquisition unit 21 may acquire by receiving from the processing device 3, the arrival date and time information indicating the arrival date and time of the unmanned aerial vehicle at the destination location. When the arrival date and time information is acquired, the acquisition unit 21 outputs the departure location information and the destination location information to the route generation unit 22 in association with the arrival date and time information. The process of the route generation device 2 when the arrival date and time information is acquired performs a similar process other than that the date and time prediction unit 232 predicts the departure date and time of departing from the destination location, and outputs the departure date and time information indicating the prediction result to the specifying unit 233.

The route generation unit 22 generates a plurality of candidate routes from a departure location to a destination location of the unmanned aerial vehicle. The route generation unit 22 can generate a candidate route on which the unmanned aerial vehicle uses the charging facility and a candidate route on which the unmanned aerial vehicle passes through the toll section. The route generation unit 22 outputs candidate route information indicating the generated candidate route to the traffic jam prediction unit 24. The candidate route information includes information indicating a route of the generated candidate route. When the route generation unit 22 generates a candidate route that uses the charging facility, the candidate route information further includes information indicating the charging facility. When the route generation unit 22 generates a candidate route that passes through a toll section, the candidate route information further includes information indicating the toll section.

The process in which the route generation unit 22 generates a candidate route will be specifically described.

The route generation unit 22 receives departure location information, departure date and time information, and destination location information from the acquisition unit 21. The route generation unit 22 generates a plurality of candidate routes from a departure location to a destination location of the unmanned aerial vehicle.

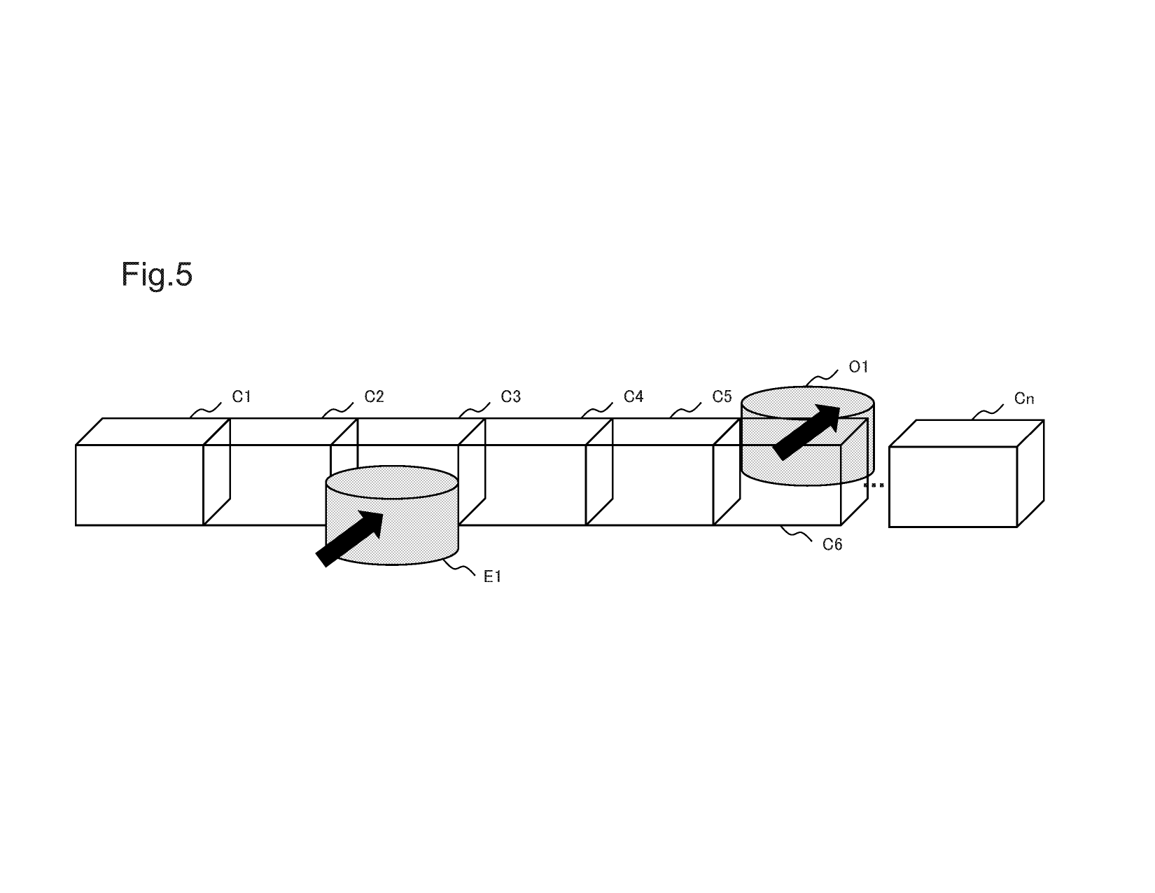

FIG. 5 is a schematic diagram schematically illustrating a corridor in the present example embodiment. The corridor is an airspace where an aerial vehicle including an unmanned aerial vehicle can fly in a specific direction. The direction in which the unmanned aerial vehicle can fly in the corridor may be different for each altitude. The corridor may be provided with a charging facility and a signal light indicating a direction in which an aerial vehicle can pass along the corridor at predetermined intervals. The corridor may be a drone highway, which is an airspace maintained to allow drones to fly safely. FIG. 5 illustrates the toll sections C1, C2, C3, C4, C5, C6, ∙∙∙, and Cn (n is a natural number of equal to or greater than 1), an entrance section E1 through which the unmanned aerial vehicle entering the toll section C3 passes, and an exit section O1 through which the unmanned aerial vehicle exiting from the toll section C6 passes. The corridor includes one or a plurality or two or more toll sections (in this example, the toll sections C1 to Cn). Each of the toll sections includes an entrance section through which the unmanned aerial vehicle entering the toll section passes and an exit section through which the unmanned aerial vehicle exiting the toll section passes. FIG. 5 is similar to the entrance section E1 through which the unmanned aerial vehicle entering the toll section C3 passes and the exit section O1 through which the unmanned aerial vehicle exiting the toll section C6 passes, and thus illustration of the other entrance sections and the other exit sections is omitted. The arrow illustrated in FIG. 5 schematically indicates the flight direction of the unmanned aerial vehicle. In the example of FIG. 5, a route in a case where the unmanned aerial vehicle that has departed from the departure location enters the toll section C3 from the entrance section E1, passes through the toll section C3 to the toll section C6, passes through the exit section O1, and goes to the destination location is illustrated.

When generating a candidate route including the toll section, the route generation unit 22 generates a candidate route including an entrance section corresponding to a departure location and an exit section corresponding to a destination location. For example, when generating a candidate route including the toll section C6 from the toll section C3 of the corridor illustrated in FIG. 5, a candidate route including the entrance section E1 corresponding to the departure location and the exit section O1 corresponding to the destination location is generated. For example, the entrance section corresponding to the departure location is the entrance section (in the example of FIG. 5, the entrance section E1) of the toll section (in the example of FIG. 5, the toll section C3) closest to the departure location among the toll sections included in the candidate route. For example, the exit section corresponding to the destination location is the exit section (in the example of FIG. 5, the exit section O1) of the toll section (in the example of FIG. 5, the toll section C6) closest to the destination location among the toll sections included in the candidate route.

The route generation unit 22 performs the following operation when generating a candidate route. The route generation unit 22 uses prohibited airspace information indicating an airspace where the flight of the unmanned aerial vehicle is prohibited to generate a candidate route that does not include the airspace where the flight of the unmanned aerial vehicle is prohibited.

For example, the route generation unit 22 generates a candidate route that bypasses an airspace where the flight of the unmanned aerial vehicle is prohibited. The prohibited airspace information is stored in the area information storage unit 26. In addition, when the flight of the unmanned aerial vehicle is prohibited only in a predetermined time zone in the airspace indicated by the prohibited airspace information, the prohibited airspace information and the prohibited time zone information indicating the time zone in which the flight of the unmanned aerial vehicle is prohibited are stored in the area information storage unit 26 in association with each other. When the unmanned aerial vehicle flies in the airspace indicated in the prohibited airspace information in a time zone that is not the time zone indicated in the prohibited time zone information, that is, in a time zone in which flight is not prohibited, the route generation unit 22 generates a candidate route including a flight path passing through the airspace indicated in the prohibited airspace information. The route generation unit 22 stops generation of a candidate route in which the unmanned aerial vehicle flies in the airspace indicated in the prohibited airspace information in the time zone indicated in the prohibited time zone information, that is, in the time zone in which the flight is prohibited.

When generating a candidate route on which the unmanned aerial vehicle passes through the toll section, the route generation unit 22 determines whether the unmanned aerial vehicle can pass through the toll section in a time zone in which the unmanned aerial vehicle is scheduled to pass through the toll section based on the corridor information stored in the area information storage unit 26. Specifically, the route generation unit 22 performs the following process. The route generation unit 22 calculates a time zone in which the unmanned aerial vehicle can pass through the toll section. The route generation unit 22 determines whether the calculated time zone is included in the time zone indicated by the time zone information of the corridor information stored in the area information storage unit 26.

The area information storage unit 26 stores corridor information indicating a corridor. The corridor information includes: corridor identification information that is information for identifying each of the corridors; corridor range information that indicates a range of the corridor; time zone information that indicates a time zone in which an unmanned aerial vehicle can pass through the corridor; and fee information related to the use of the corridor.

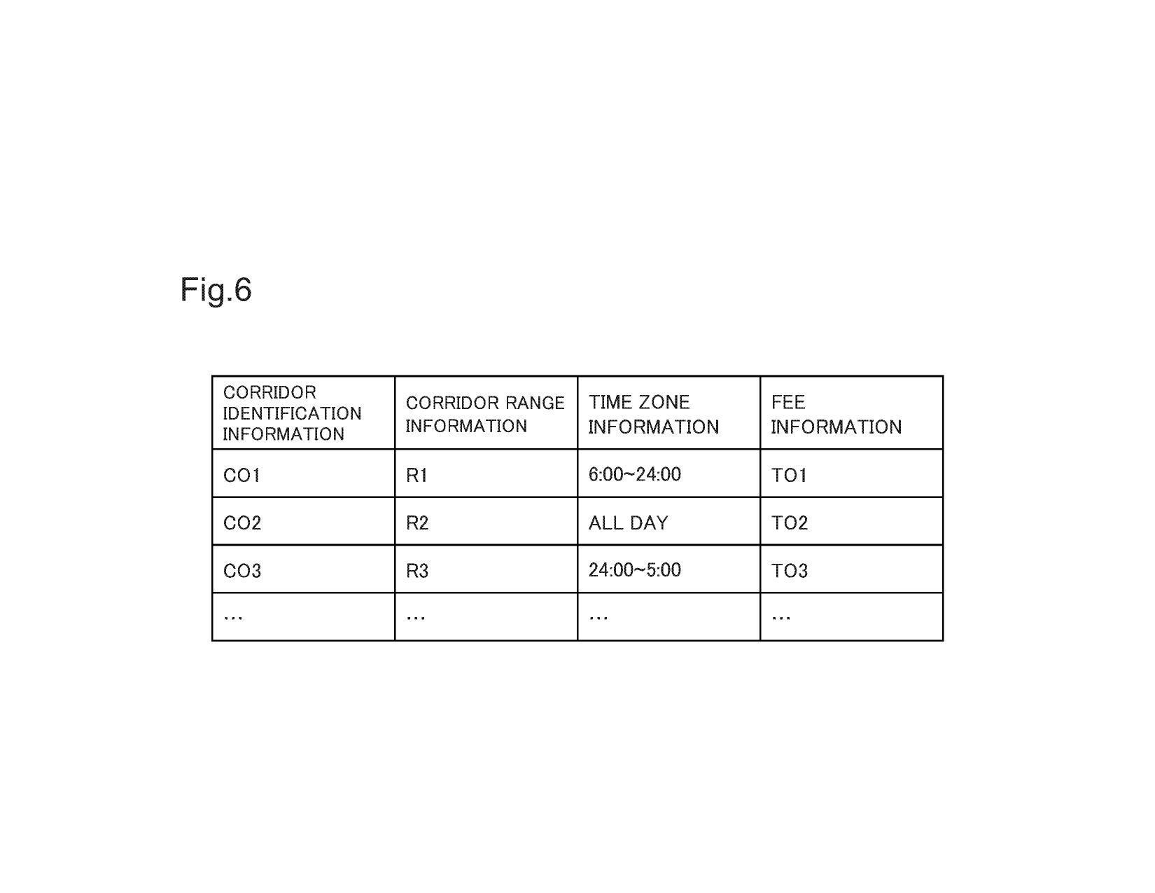

FIG. 6 is a diagram illustrating an example of the corridor information stored in the area information storage unit 26 of the route generation device 2. In this example, for each of the corridors whose corridor identification information is “CO1”, “CO2”, and “CO3”, the corridor range information indicating the range of the respective corridors, the time zone information, and the fee information are stored in the area information storage unit 26 as the corridor information.

When the calculated time zone is included in the time zone indicated by the time zone information of the corridor information stored in the area information storage unit 26, the route generation unit 22 determines that the toll section to be determined can be passed through. When the calculated time zone is not included in the time zone indicated by the time zone information of the corridor information stored in the area information storage unit 26, that is, not included in the time zone in which the unmanned aerial vehicle can pass through the corridor, the route generation unit 22 determines that the toll section to be determined cannot be passed through. When determined that the vehicle cannot be passed through, the route generation unit 22 stops generation of candidate routes including the toll section to be determined. As described above, in a case where the unmanned aerial vehicle cannot pass through the toll section of the corridor in the time zone in which the unmanned aerial vehicle can pass, the route generation unit 22 stops the generation of the candidate route.

A case where the corridor is provided above a river is assumed. When the corridor is provided above the river, it is assumed that the corridor is available all day as in the second line of FIG. 6. Alternatively, the corridor may be provided above the railway track. In a case where the corridor is provided above the railway track, the train passes on the railway track during the day, and thus it is assumed that the sky above the railway track is used as the corridor at night when the train does not pass on the railway track. Alternatively, the corridor information may include information indicating a train operation plan. Based on the information indicating the train operation plan, the route generation unit 22 may generate a candidate route including a part of a corridor on the railway track in a time zone in which the train does not pass on the railway track as a toll section through which the unmanned aerial vehicle can pass. As described above, in a case where the toll section through which the unmanned aerial vehicle can pass only in a predetermined time zone is included, the route generation unit 22 generates a candidate route based on the time zone in which the unmanned aerial vehicle can pass through the corridor.

The route generation unit 22 generates a flight path of the unmanned aerial vehicle by further using the parameters stored in the area information storage unit 26. In addition, the route generation unit 22 generates a flight path using parameters related to a flight plan of another unmanned aerial vehicle. The parameters related to the flight plan of another unmanned aerial vehicle are, for example, a value indicated in flight plan information of another unmanned aerial vehicle stored in the flight plan storage unit 27 described later. The area information storage unit 26 further stores, for example, a parameter indicating the position of the charging facility, a parameter related to weather, a parameter related to the flying ability of the unmanned aerial vehicle, and a parameter related to the cargo transported by the unmanned aerial vehicle.

For example, the parameter indicating the position of the charging facility is stored in the area information storage unit 26 in the following manner. Every time a charging facility is newly installed, an administrator of the route generation system performs an operation input for a parameter indicating a position of the charging facility via an input/output interface (not illustrated) of the route generation device 2. Upon receiving the operation input for the parameter indicating the position of the charging facility, the acquisition unit 21 of the route generation device 2 causes the area information storage unit 26 to store the parameter indicating the position of the charging facility corresponding to the operation input.

For example, the parameter related to the weather includes a parameter indicating the wind direction and a parameter indicating the wind speed. For example, the acquisition unit 21 of the route generation device 2 acquires a parameter related to weather from a server of a weather observation system outside the route generation system at a predetermined frequency. Every time a parameter related to weather is acquired, the acquisition unit 21 causes the area information storage unit 26 to store the acquired parameter related to weather.

For example, the parameter related to the flying ability of the unmanned aerial vehicle include a parameter indicating a flying speed of the unmanned aerial vehicle, a parameter indicating a charge amount of the unmanned aerial vehicle, a parameter indicating an altitude at which the unmanned aerial vehicle can fly, and a parameter indicating a cruisable distance. It is assumed that the parameter related to the flying ability of the unmanned aerial vehicle is defined by the specification of the unmanned aerial vehicle. For example, upon receiving the operation input for the parameter related to the flying ability of the unmanned aerial vehicle for each model from the user of the route generation system, the acquisition unit 21 of the route generation device 2 stores the parameter related to the flying ability of the unmanned aerial vehicle corresponding to the operation input in the area information storage unit 26.

For example, the parameters related to the cargo transported by the unmanned aerial vehicle include a parameter indicating whether the cargo is highly urgent and a parameter indicating the weight of the cargo. For example, upon receiving an operation input for a parameter related to a cargo transported by the unmanned aerial vehicle from a user of the route generation system, the acquisition unit 21 of the route generation device 2 stores the parameter related to the cargo transported by the unmanned aerial vehicle corresponding to the operation input in the area information storage unit 26.

In this manner, the acquisition unit 21 of the route generation device 2 may acquire the parameter from a server outside the route generation system at a predetermined frequency. Each time the parameter is acquired, the acquisition unit 21 may store the acquired parameter in the area information storage unit 26. Alternatively, upon receiving an operation input for a parameter from a user who uses the route generation system or an administrator who manages the route generation system, the acquisition unit 21 of the route generation device 2 may store the parameter corresponding to the operation input in the area information storage unit 26.

The traffic jam prediction unit 24 is an example of a traffic jam prediction means. Candidate route information is input to the traffic jam prediction unit 24 from the route generation unit 22. The traffic jam prediction unit 24 reads flight plan information indicating a flight plan of another unmanned aerial vehicle from the flight plan storage unit 27. The other unmanned aerial vehicle is an unmanned aerial vehicle other than the unmanned aerial vehicle for which a candidate route is to be generated.

The flight plan storage unit 27 stores flight plan information of another unmanned aerial vehicle. The flight plan information includes unmanned aerial vehicle identification information capable of identifying each unmanned aerial vehicle, flight plan identification information that is information for identifying a flight plan, departure location information, departure date and time information, destination location information, arrival date and time information, and flight path information indicating a flight path. The unmanned aerial vehicle identification information is, for example, an unmanned aerial vehicle identifier (ID) capable of identifying each unmanned aerial vehicle. The unmanned aerial vehicle identification information used by the route generation device 2 may be unmanned aerial vehicle identification information included in a remote identification (ID) issued from the unmanned aerial vehicle. The remote ID is information transmitted by the unmanned aerial vehicle during flight. The remote ID includes unmanned aerial vehicle identification information, information capable of identifying each owner of the unmanned aerial vehicle, position information of the unmanned aerial vehicle, and the like. The departure date and time information indicates the departure date and time of the unmanned aerial vehicle from the departure location. The arrival date and time information indicates the arrival date and time of the unmanned aerial vehicle at the destination location. In a case where the flight path includes a toll section, the flight path information includes information indicating an entrance section that is a space that enters the toll section and information indicating an exit section that is a space that exits from the toll section.

The flight plan information may include information indicating whether the unmanned aerial vehicle has insurance. The insurance fee may be set to be lower for an unmanned aerial vehicle that uses a corridor than for an unmanned aerial vehicle that does not use a corridor. The acquisition unit 21 may acquire, from the processing device 3, information indicating whether it is desired to take a response at the time of an emergency or use an insurance capable of receiving the aircraft recovery service in a case where the unmanned aerial vehicle has crashed. The insurance fee may be a fee corresponding to the presence or absence of use of the corridor and the flight time, or may be a fee corresponding to the flight path. For example, in a case where the flight path is a route that passes over an urban area or through an airspace where a plurality of aerial vehicles fly outside a corridor, it is assumed that the insurance fee increases. The route information generation unit 234 of the processing unit 23 described later may output the route information including the information indicating insuring of insurance in a format that can be output according to a predetermined format.

The traffic jam prediction unit 24 predicts the occurrence of traffic jam in the candidate route indicated by the candidate route information based on the flight plan information of another unmanned aerial vehicle read from the flight plan storage unit 27. The “traffic jam” refers to a state in which the unmanned aerial vehicle does not smoothly flow but stays in the flight path. For example, in order to prevent the unmanned flight bodies equal to or more than the upper limit number that can pass per unit section from passing, it is assumed that when the leading unmanned aerial vehicle has finished passing through the section, the subsequent unmanned aerial vehicle is allowed to enter the section and the unmanned aerial vehicles are caused to sequentially pass through the section. In this case, the unmanned aerial vehicle hovers in the air and stands by until passage is permitted.

When the occurrence of traffic jam is predicted, the traffic jam prediction unit 24 outputs section information indicating a section in which the occurrence of traffic jam is predicted to the route generation unit 22. When the occurrence of traffic jam is not predicted, the traffic jam prediction unit 24 outputs candidate route information of a candidate route for which the occurrence of traffic jam is not predicted to the processing unit 23.

The traffic jam prediction unit 24 can predict occurrence of traffic jam by an arbitrary method. For example, the traffic jam prediction unit 24 performs a simulation for a case where an unmanned aerial vehicle is caused to fly according to a candidate route and another unmanned aerial vehicle is caused to fly according to a flight plan of another unmanned aerial vehicle. As a result of the simulation, when there is a section in which a predetermined number or more unmanned aerial vehicles are present per unit section at a certain time, the traffic jam prediction unit 24 predicts that traffic jam will occur in that section of the candidate route.

When the occurrence of traffic jam is predicted by the traffic jam prediction unit 24, section information indicating a section in which the occurrence of traffic jam is predicted is input from the traffic jam prediction unit 24 to the route generation unit 22. When receiving input of section information indicating a section in which occurrence of traffic jam is predicted, the route generation unit 22 generates a candidate route including a detour that detours the section in which occurrence of traffic jam is predicted indicated in the section information. The route generation unit 22 outputs candidate route information indicating the candidate route including the detour to the processing unit 23. The route generation unit 22 may output, to the processing unit 23, information indicating a candidate route for which occurrence of traffic jam is predicted of a generation source of a candidate route including a detour in association with the candidate route information indicating a candidate route including a detour. In addition, the route generation unit 22 may output, to the processing unit 23, candidate route information indicating a candidate route for which occurrence of traffic jam is predicted.

The route generation unit 22 may output candidate route information indicating a candidate route including a detour to the traffic jam prediction unit 24 and cause the traffic jam prediction unit 24 to predict occurrence of traffic jam on a detour of a newly generated candidate route.

The processing unit 23 includes a fee calculation unit 231, a date and time prediction unit 232, a specifying unit 233, and a route information generation unit 234.

The processing unit 23 performs a process for outputting route information indicating a candidate route that satisfies a predetermined condition among the plurality of generated candidate routes. The processing unit 23 outputs the route information in a format capable of outputting the route indicated by the candidate route satisfying the predetermined condition according to a predetermined format.

The fee calculation unit 231 is an example of a fee calculation means. The candidate route information is input to the fee calculation unit 231 from the traffic jam prediction unit 24.

When the candidate route information includes information indicating the toll section, the fee calculation unit 231 reads, from the area information storage unit 26, fee information associated with the corridor identification information of the corridor including the toll section indicated in the information indicating the toll section. The fee calculation unit 231 calculates a toll corresponding to the toll section indicated in the information indicating the toll section from the fee indicated in the fee information. The fee calculation unit 231 outputs toll information indicating a calculation result to the specifying unit 233.

When the candidate route information includes the information indicating the charging facility, the fee calculation unit 231 calculates the usage fee of the charging facility indicated by the information indicating the charging facility. The fee calculation unit 231 outputs usage fee information indicating a calculation result to the specifying unit 233. Information for calculating the usage fee of the charging facility (e.g., information indicating a usage fee per unit time for each charging facility) may be stored in advance in the area information storage unit 26.

The fee calculation unit 231 may calculate the utilization fee of the insurance. The fee calculation unit 231 may add the utilization fee of the insurance to the toll of the toll section. Alternatively, the insurance fee may be set according to the type and weight of the object to be transported by the unmanned aerial vehicle, or may be set according to the size of the unmanned aerial vehicle. In addition, insurance fees and insurance compensation may be set depending on whether the unmanned aerial vehicle is controlled by remote control or performs autonomous flight.

For example, it is assumed that a toll set for an insured unmanned aerial vehicle is set to be lower than a toll set for an uninsured unmanned aerial vehicle. The fee calculation unit 231 may calculate the toll of the insured unmanned aerial vehicle and the toll of the uninsured unmanned aerial vehicle based on the fee information indicating the fee set to the insured unmanned aerial vehicle and the fee information indicating the fee set to the uninsured unmanned aerial vehicle. The display control unit 33 of the processing device 3 to be described later may display the insurance fee on the display device.

The date and time prediction unit 232 is an example of a date and time prediction means. The date and time prediction unit 232 predicts the date and time when the unmanned aerial vehicle arrives at the destination location in a case where the unmanned aerial vehicle departs at the date and time indicated in the departure date and time information and flies along the route indicated by the candidate route. The date and time prediction unit 232 outputs arrival date and time information indicating a prediction result to the specifying unit 233.

The date and time prediction unit 232 predicts, for example, the date and time of arrival as follows. The date and time prediction unit 232 calculates the required time required by the unmanned aerial vehicle for the movement of the candidate route. For example, the date and time prediction unit 232 predicts the required time by using a parameter related to weather which is a parameter stored in the area information storage unit 26, a parameter related to the flying ability of the unmanned aerial vehicle, and a parameter indicating the weight of the cargo. The date and time prediction unit 232 predicts the date and time when the required time has elapsed from the departure date and time indicated by the departure date and time information as the date and time of arriving at the destination location. In a case where the date and time of the candidate route that uses the charging facility are predicted, the date and time prediction unit 232 predicts that the date and time when the required time required by the unmanned aerial vehicle for the movement of the candidate route and the time required for charging have elapsed from the departure date and time is the date and time of arriving at the destination location.

The specifying unit 233 is an example of a specifying means. The specifying unit 233 specifies a candidate route satisfying a predetermined condition among the generated candidate routes. The specifying unit 233 specifies a candidate route satisfying a predetermined condition using the candidate route information input from the traffic jam prediction unit 24 or the route generation unit 22, the toll information input from the fee calculation unit 231, the usage fee information, and the arrival date and time information input from the date and time prediction unit 232.

The predetermined condition is, for example, a route that satisfies a condition of arriving at the destination location earliest. Alternatively, the predetermined condition is a condition that the toll is the lowest. Alternatively, the predetermined condition is a condition of being the candidate route that uses the charging facility. The specifying unit 233 may specify a candidate route satisfying a predetermined condition from candidate routes predicted that traffic jam will not occur, excluding candidate routes predicted that traffic jam will occur. For example, a predetermined condition is set in advance by the route generation device 2, an administrator of the route generation system, or a user of the route generation system. One condition may be set as the predetermined condition, or a plurality or two or more conditions may be set as the predetermined condition.

Alternatively, for example, the input/output unit 31 of the processing device 3 may receive an operation input of a user of the route generation system for setting of a predetermined condition that “wants to lower the fee although it may take time”. The transmission/reception unit 32 of the processing device 3 transmits the setting information corresponding to the operation input to the route generation device 2. The setting information is information used by the route generation device 2 to set a predetermined condition. The setting information may be information indicating a predetermined condition or may be information indicating a request of the user.

The acquisition unit 21 of the route generation device 2 outputs the setting information to the processing unit 23. The specifying unit 233 of the processing unit 23 sets a condition corresponding to the operation input of the user based on the setting information. The specifying unit 233 uses the set condition as a predetermined condition. For example, the specifying unit 233 sets the “condition that the toll is the lowest” to a predetermined condition according to setting information indicating a request of a user who “wants to lower the fee although it may take time”. Alternatively, in a case where the setting information is information indicating a predetermined condition (e.g., “condition that the toll is the lowest”), the specifying unit 233 sets the condition (e.g., “condition that the toll is the lowest”) indicated in the information indicating the predetermined condition as the predetermined condition.

The specifying unit 233 outputs candidate route related information indicating information related to the specified candidate route and candidate route information of the specified candidate route to the route information generation unit 234 in association with each other. For example, the candidate route related information includes altitude information indicating an altitude of flight, information indicating a toll section, toll information, information indicating whether a route assumed to use a charging facility, usage fee information of a charging facility, information indicating whether a traffic jam is predicted, and arrival date and time information. The candidate route related information may include, for a candidate route including a detour, information indicating a candidate route for which occurrence of traffic jam is predicted of a generation source of the candidate route including the detour. The candidate route related information includes arbitrary information related to the candidate route.

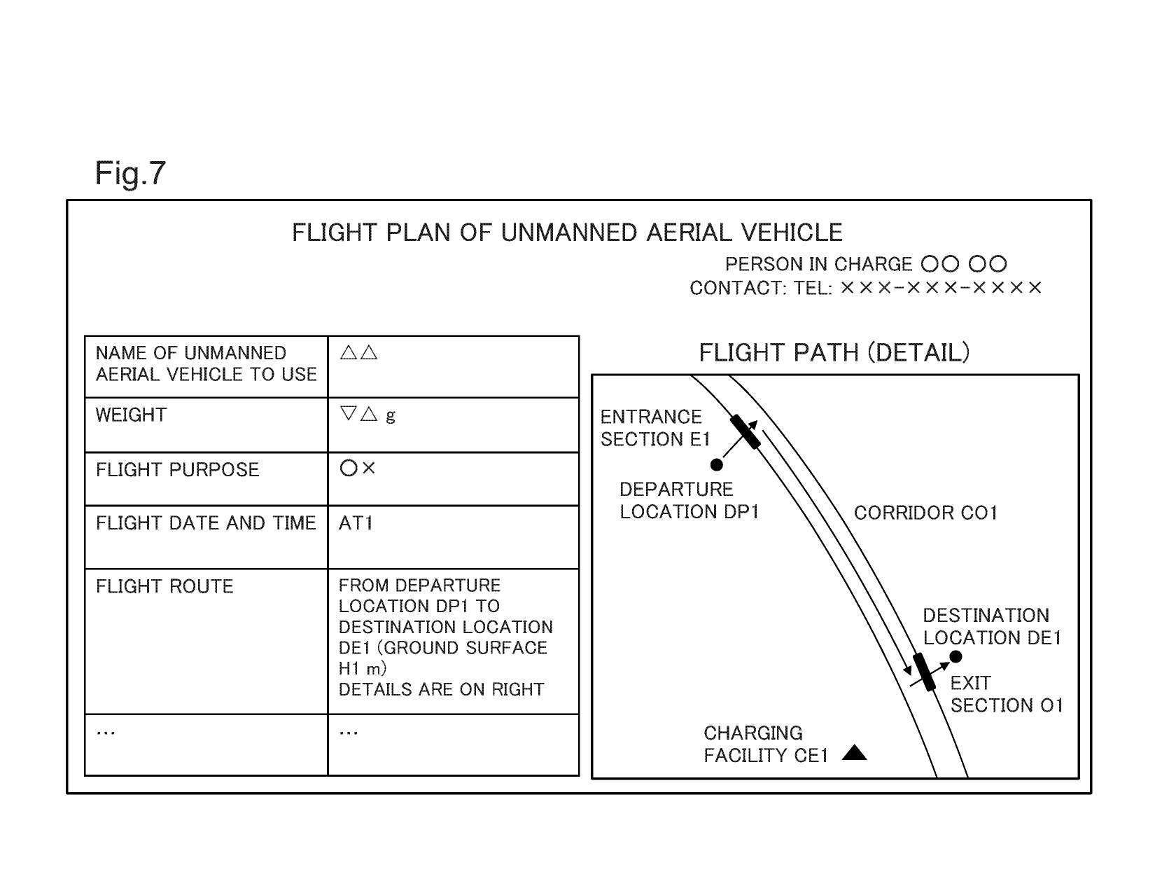

The route information generation unit 234 is an example of a route information generation means. The route information generation unit 234 receives the candidate route information and the candidate route related information from the specifying unit 233. When the candidate route including the detour is specified by the specifying unit 233, the route information output by the processing unit 23 includes the route including the detour. The route information generation unit 234 generates route information in a format capable of outputting a route indicated by a candidate route satisfying a predetermined condition according to a predetermined format. The route information generation unit 234 outputs the generated route information to the transmission unit 25. The predetermined format will be described with reference to FIGS. 7 to 9.

FIGS. 7 to 9 are examples of a case where the route information generated in a format that can be output according to a predetermined format is output. FIGS. 7 to 9 are examples of a case where the processing device 3 receives an operation input of the user with respect to the departure location information indicating the departure location DP1 of the unmanned aerial vehicle, the destination location information indicating the destination location DE1, and the departure date and time information indicating the departure date and time DT1.

FIG. 7 is an example of a case where the route information generated in a format that can be output according to the format of the flight plan is output. For example, the flight plan is an application form that is required to be submitted by a government office or a local government when flying an unmanned aerial vehicle.

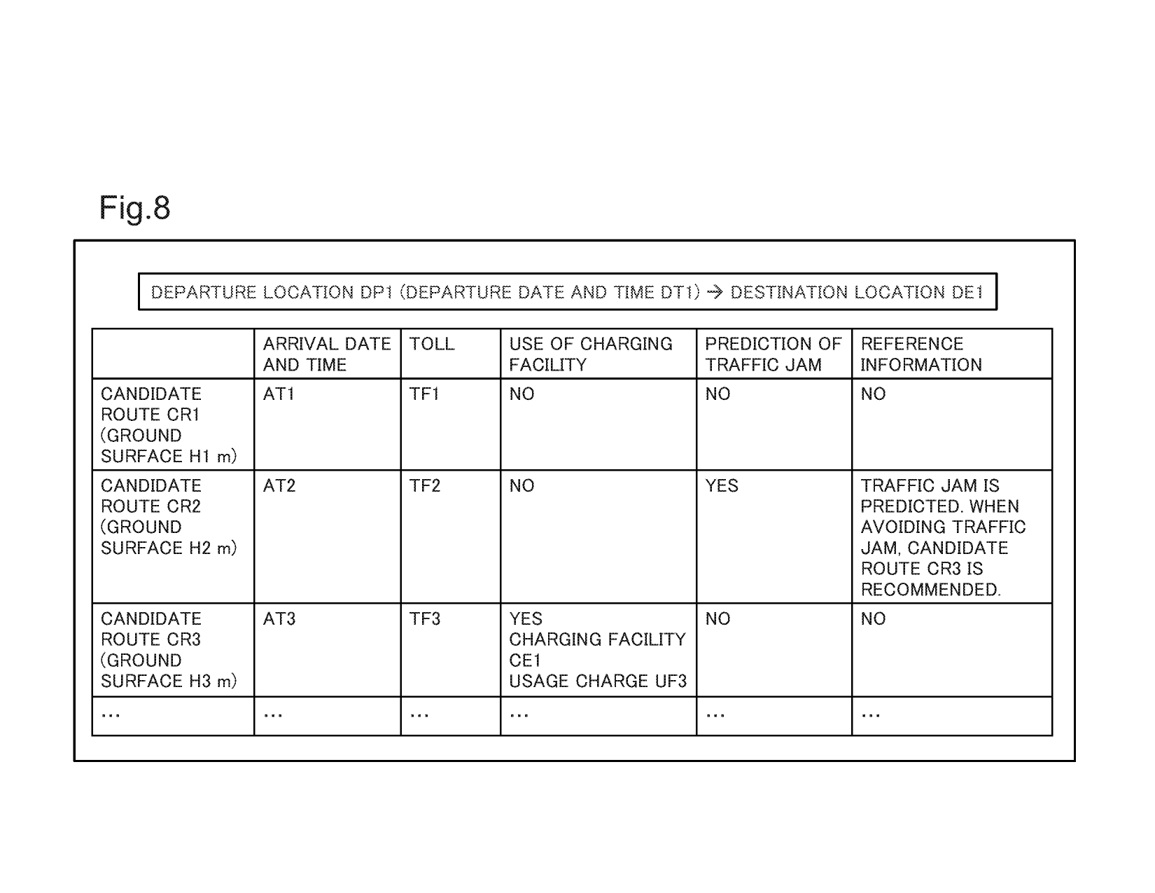

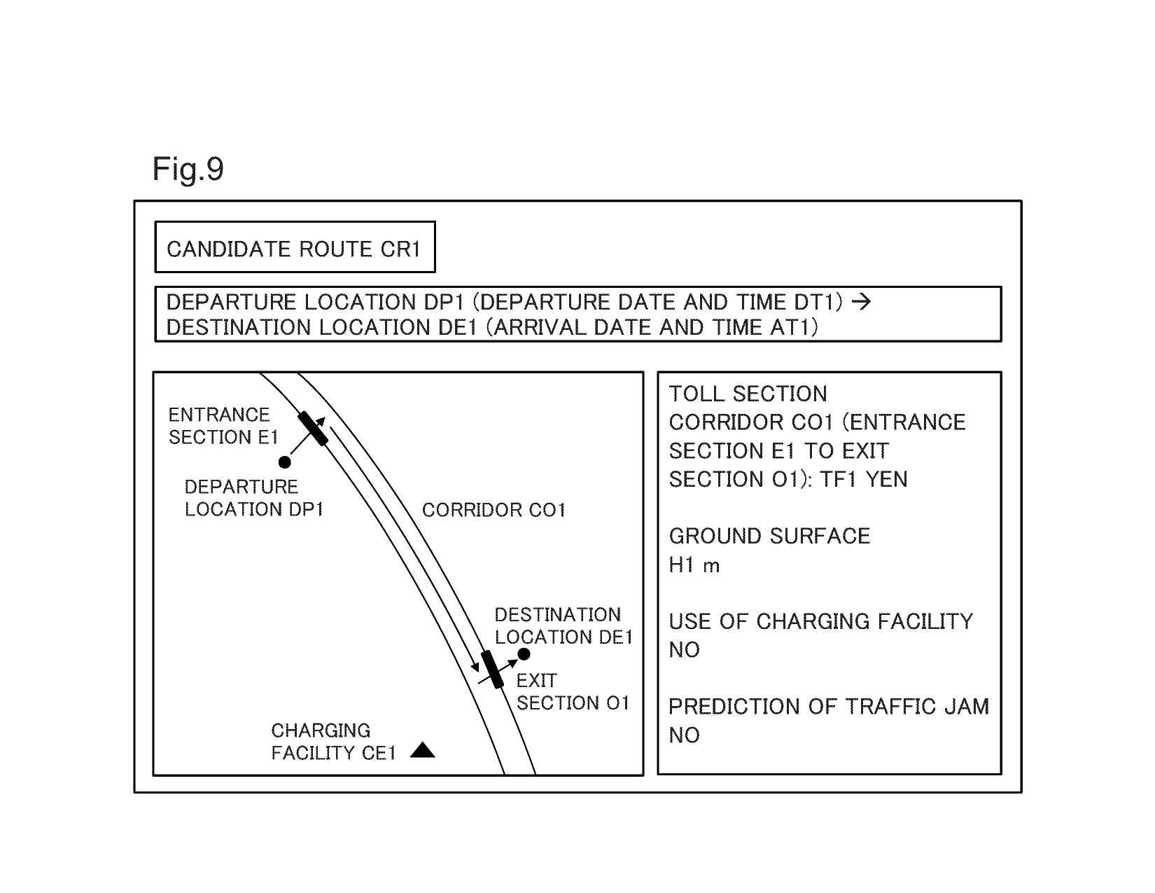

In the example illustrated in FIG. 7, the route of the candidate route CR1 illustrated in FIG. 8 to be described later is output according to the format of the flight plan. Specifically, in FIG. 7, “AT1”, which is the arrival date and time indicated in the arrival date and time information of the candidate route related information of the candidate route CR1, and the flight path (“H1” which is the altitude indicated by the altitude information indicating the altitude at which the unmanned aerial vehicle flies and “departure location DP1 to destination location DE1”) are output. In addition, in FIG. 7, a map illustrating the flight path is output according to the format of the flight plan. The map illustrating the flight path will be described in detail in the description of FIG. 9.

In addition, it is assumed that information other than the information regarding the route needs to be described in the flight plan. For example, in the format of the flight plan illustrated in FIG. 7, the name of the unmanned aerial vehicle to be used, the weight, the flight purpose, the name of the person in charge, and the contact of the responsible person are output. Information other than the information regarding the route may be stored in the flight plan storage unit 27 in advance, or the acquisition unit 21 may acquire the information from the processing device 3 or another device. The route information generation unit 234 may output the route information in a format capable of outputting (e.g., FIG. 7) the route indicated by the candidate route satisfying a predetermined condition and information other than the information regarding the route according to a predetermined format.

FIG. 8 illustrates an example of a case where the route information generated in a format that can be output according to the format representing the candidate routes in the list is output. FIG. 8 illustrates candidate route related information of each of the candidate route CR1 to the candidate route CR3 and the candidate route CR1 to the candidate route CR3. The route information generation unit 234 may generate reference information from information indicating a candidate route (in the example of FIG. 8, the candidate route CR2) for which occurrence of traffic jam is predicted of a generation source of a candidate route (in the example of FIG. 8, the candidate route CR3) including a detour which is the candidate route related information. As illustrated in FIG. 8, the reference information includes information for displaying a message "traffic jam is predicted. When avoiding a traffic jam, the candidate route CR3 is recommended". The details of the route such as the departure location, which toll section to enter from the entrance section, and how far to pass through the toll section and which exit section to pass through to the destination location may be output in a list.

FIG. 9 illustrates an example of a case where the route information generated in a format that can be output according to a format using a map is output. The route information generation unit 234 outputs route information including a route indicated by the candidate route, the position of the charging facility, the position of the entrance section of the corridor, the position of the exit section of the corridor, and the map data in which topography is registered. When a charging facility installed in a charging spot including a plurality of charging facilities is specified, the position of the charging spot may be registered in the map data.

The map on the left side of FIG. 9 is an example of a map showing the details of the flight path based on the map data. The map of FIG. 9 illustrates a route of a candidate route CR1 including a departure location DP1, a route from the departure location DP1 to an entrance section E1, a route from the entrance section E1 to an exit section O1, and a route from the exit section O1 to a destination location DE1. In addition, the charging facility CE1 near the destination location DE1 is illustrated in the map of FIG. 9.

In the example of FIG. 9, a map image based on the map data of the candidate route CR1 and the candidate route related information are output. In FIG. 9, information similar to the information indicated for the candidate route CR1 in the first line of FIG. 8 is output, except that it is displayed that it enters the corridor CO1 from the entrance section E1 and passes through the exit section O1 from the corridor CO1. The corridor CO1 is schematically illustrated in FIG. 5.

The route information generation unit 234 may generate the route information in a format that can be output according to any one of the formats of FIGS. 7 to 9. Alternatively, the route information generation unit 234 may generate the route information in a format that can be output according to each format for a plurality of types of formats.

The transmission unit 25 receives route information from the processing unit 23. The transmission unit 25 transmits the route information to a predetermined communication destination. The communication destination may be set in advance. The communication destination may be set based on an operation of an input/output interface (not illustrated) of the user. In the following description, a case where the processing device 3 is a communication destination will be described as an example.

A configuration of the processing device 3 of the present example embodiment will be described in detail with reference to FIG. 3. The processing device 3 includes an input/output unit 31, a transmission/reception unit 32, and a display control unit 33.

The processing device 3 in a case where the departure location information and the destination location information are transmitted to the route generation device 2 will be described in detail.

The input/output unit 31 receives an input (operation input) based on a user's operation for inputting a departure location of the unmanned aerial vehicle, a departure date and time of the unmanned aerial vehicle, and a destination location. The input/output unit 31 outputs the departure location information, the departure date and time information, and the destination location information to the transmission/reception unit 32 in association with each other according to the operation input.

Alternatively, the input/output unit 31 may receive an operation input for inputting the arrival date and time of the unmanned aerial vehicle at the destination location. The input/output unit 31 may output the arrival date and time information associated with the departure location information and the destination location information to the transmission/reception unit 32 based on the operation input.

The transmission/reception unit 32 receives the departure location information, the departure date and time information, and the destination location information. The transmission/reception unit 32 transmits the departure location information, the departure date and time information, and the destination location information to the route generation device 2 in association with each other. The transmission/reception unit 32 may transmit the departure location information, the destination location information, and the arrival date and time information to the route generation device 2 in association with each other.

The processes of the processing device 3 in a case where the route indicated by the candidate route is displayed on the display device (not illustrated) in a predetermined format based on the route information will be described in detail. The processes of outputting the route indicated by the candidate route in a predetermined format based on the route information are performed by a device that has received the route information from the route generation device 2. A device different from the processing device 3 may receive the route information and present the route to the user in a predetermined format based on the route information.

The transmission/reception unit 32 receives the route information from the route generation device 2. The transmission/reception unit 32 outputs the route information to the display control unit 33.

The display control unit 33 causes the display device to display the route indicated by the candidate route in a predetermined format based on the route information. The display device may be incorporated in the processing device 3 or may be another device connected to the processing device 3 via a communication interface. An example in which the route indicated by the candidate route is displayed on the display device in a predetermined format based on the route information is, for example, an example in FIGS. 7 to 9.

For example, the display control unit 33 causes the display device to display any of the display examples of FIGS. 7 to 9 based on the route information. Alternatively, the display control unit 33 of the processing device 3 may display a route as follows for a plurality of types of formats based on the route information in a format that can be output according to each format. First, the route information may be displayed in a list as illustrated in FIG. 8. Then, the display control unit 33 may cause the display device to display the route information selected from the list (e.g., FIG. 8) according to the user's operation input in a format using a map (e.g., FIG. 9) or a format of a flight plan (e.g., FIG. 7).

As described above, the route generation device 2 acquires the departure location information indicating the departure location of the unmanned aerial vehicle and the destination location information indicating the destination location, and generates a plurality of candidate routes from the departure location to the destination location of the unmanned aerial vehicle. The route generation device 2 performs a process for outputting route information indicating a candidate route that satisfies a predetermined condition among a plurality of generated candidate routes. The route generation device 2 outputs route information in a format capable of outputting a route indicated by a candidate route satisfying a predetermined condition according to a predetermined format. The route generation device 2 can present the route corresponding to the request of the user operating the unmanned aerial vehicle in a format according to the predetermined format by outputting the route information in a format capable of outputting the route indicated by the candidate route satisfying the predetermined condition according to a predetermined format.

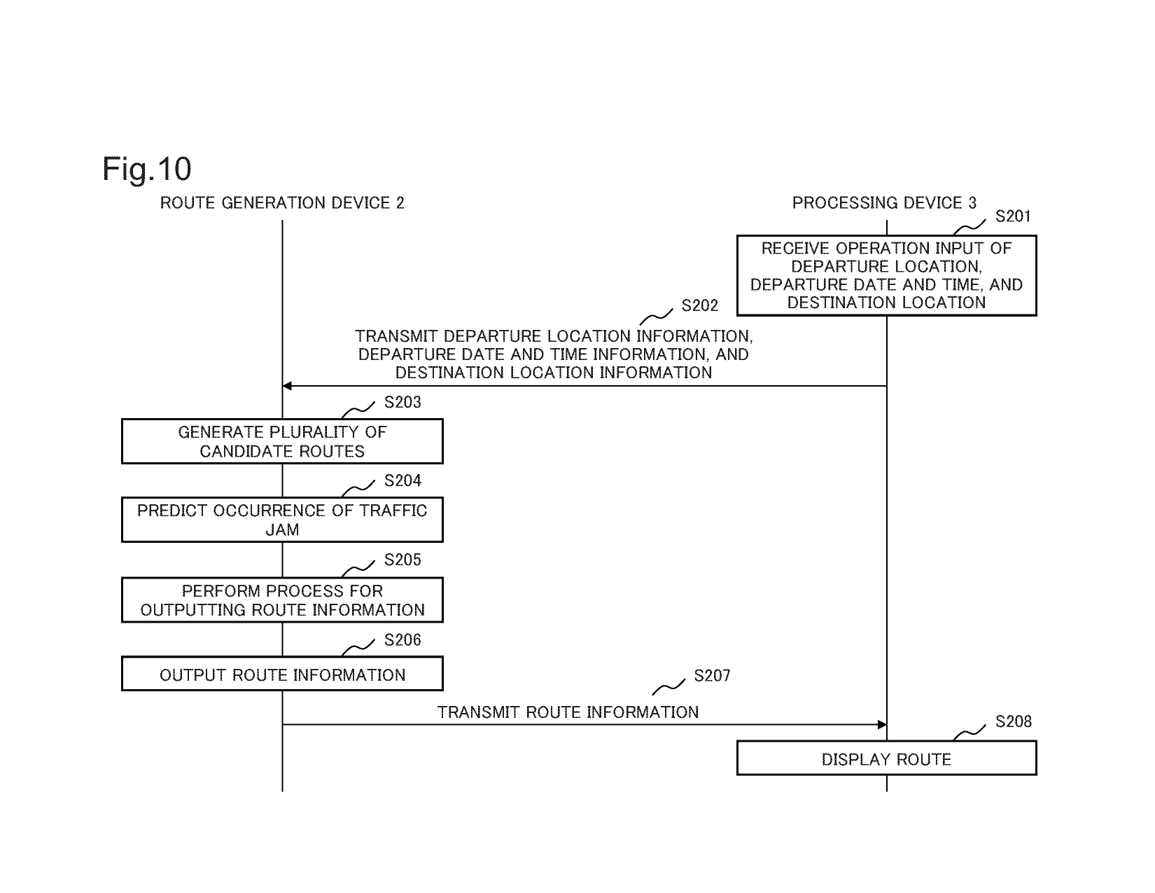

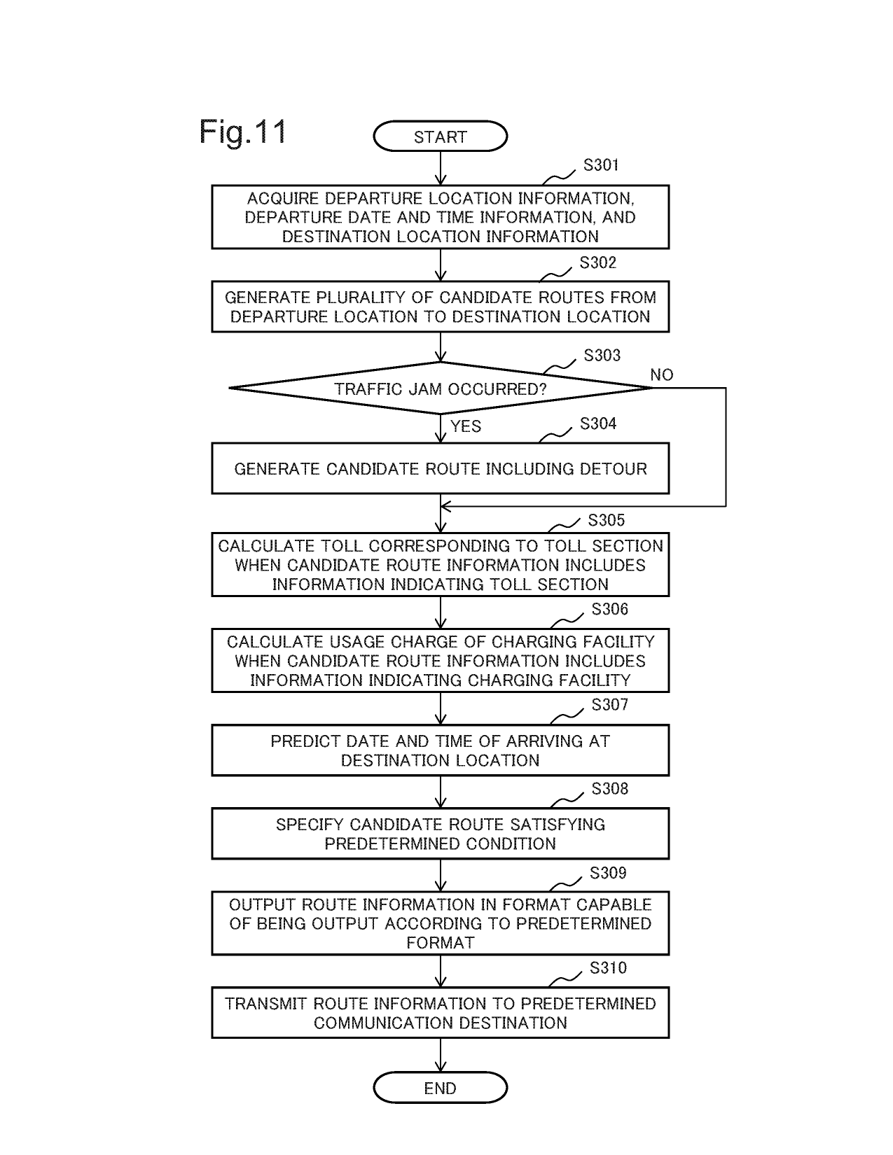

Next, an operation example of the route generation system of the present example embodiment will be described with reference to FIGS. 10 to 11. FIG. 10 is a sequence diagram illustrating an operation example of the route generation system. FIG. 11 is a flowchart illustrating an operation example of the route generation device 2.

First, the operation of the route generation system will be described with reference to FIG. 10.

The input/output unit 31 of the processing device 3 receives an operation input of a user for inputting a departure location of the unmanned aerial vehicle, a departure date and time of the unmanned aerial vehicle, and a destination location (step S201). The input/output unit 31 outputs the departure location information, the departure date and time information, and the destination location information to the transmission/reception unit 32 according to the operation input.

The transmission/reception unit 32 receives the departure location information, the departure date and time information, and the destination location information. The transmission/reception unit 32 transmits the departure location information, the departure date and time information, and the destination location information to the route generation device 2 in association with each other (step S202).

The acquisition unit 21 of the route generation device 2 acquires the departure location information, the departure date and time information, and the destination location information by receiving the departure location information of the unmanned aerial vehicle, the departure date and time information indicating the departure date and time of the unmanned aerial vehicle, and the destination location information from the processing device 3.

The route generation unit 22 generates a plurality of candidate routes from a departure location to a destination location of the unmanned aerial vehicle (step S203). The route generation unit 22 outputs candidate route information indicating the generated candidate route to the traffic jam prediction unit 24.

The traffic jam prediction unit 24 predicts the occurrence of traffic jam in the candidate route indicated by the candidate route information based on the flight plan information of another unmanned aerial vehicle read from the flight plan storage unit 27 (step S204). When the occurrence of traffic jam is predicted, the traffic jam prediction unit 24 outputs section information indicating a section in which the occurrence of traffic jam is predicted to the route generation unit 22. When the occurrence of traffic jam is not predicted, the traffic jam prediction unit 24 outputs candidate route information of a candidate route for which the occurrence of traffic jam is not predicted to the processing unit 23.

When the occurrence of traffic jam is predicted by the traffic jam prediction unit 24, section information indicating a section in which the occurrence of traffic jam is predicted is input from the traffic jam prediction unit 24 to the route generation unit 22. The route generation unit 22 generates a candidate route including a detour that bypasses a section in which occurrence of traffic jam indicated in the section information is predicted. The route generation unit 22 outputs candidate route information indicating the candidate route including the detour to the processing unit 23.

The processing unit 23 performs a process for outputting route information indicating a candidate route that satisfies a predetermined condition among the plurality of candidate routes generated by the route generation unit 22 (step S205). The processing unit 23 outputs the route information in a format capable of outputting the route indicated by the candidate route satisfying the predetermined condition according to a predetermined format (step S206).

The transmission unit 25 receives route information from the processing unit 23. The transmission unit 25 transmits the route information to a predetermined communication destination (step S207). In FIG. 10, a case where the route information is transmitted to the processing device 3 in step S207 will be described as an example.

The transmission/reception unit 32 of the processing device 3 receives the route information. The transmission/reception unit 32 outputs the route information to the display control unit 33.

The display control unit 33 causes the display device to display the route indicated by the candidate route in a predetermined format based on the route information (step S208).

Next, the operation of the route generation device 2 will be described with reference to FIG. 11. The operation of FIG. 11 details the operation of steps S203 to S207 of FIG. 10.

The acquisition unit 21 receives the departure location information, the departure date and time information, and the destination location information of the unmanned aerial vehicle from the processing device 3 to acquire the departure location information, the departure date and time information, and the destination location information (step S301).

The route generation unit 22 receives departure location information, departure date and time information, and destination location information from the acquisition unit 21. The route generation unit 22 generates a plurality of candidate routes from a departure location to a destination location of the unmanned aerial vehicle (step S302). The route generation unit 22 outputs candidate route information indicating the generated candidate route to the traffic jam prediction unit 24.

The traffic jam prediction unit 24 predicts the occurrence of traffic jam in the candidate route indicated by the candidate route information based on the flight plan information of another unmanned aerial vehicle read from the flight plan storage unit 27 (step S303).

When the occurrence of traffic jam is predicted (YES in step S303), the traffic jam prediction unit 24 outputs section information indicating a section in which the occurrence of traffic jam is predicted to the route generation unit 22. The route generation unit 22 generates a candidate route including a detour that bypasses a section in which occurrence of traffic jam is predicted indicated in the section information (step S304). The route generation unit 22 outputs candidate route information indicating the candidate route including the detour to the processing unit 23.

When the occurrence of traffic jam is not predicted (NO in step S303), the traffic jam prediction unit 24 outputs the candidate route information of the candidate route for which the occurrence of traffic jam is not predicted to the processing unit 23. The route generation unit 22 does not perform the operation of step S304.

When the candidate route information includes the information indicating the toll section, the fee calculation unit 231 of the processing unit 23 calculates a toll corresponding to the toll section indicated by the information indicating the toll section (step S305). The fee calculation unit 231 outputs toll information indicating a calculation result to the specifying unit 233.

When the candidate route information includes the information indicating the charging facility, the fee calculation unit 231 calculates the usage fee of the charging facility indicated by the information indicating the charging facility (step S306). The fee calculation unit 231 outputs usage fee information indicating a calculation result to the specifying unit 233.

The date and time prediction unit 232 predicts the date and time when the unmanned aerial vehicle arrives at the destination location in a case where the unmanned aerial vehicle departs at the date and time indicated in the departure date and time information and flies along the route indicated by the candidate route (step S307). The date and time prediction unit 232 generates arrival date and time information indicating a prediction result and outputs the arrival date and time information to the specifying unit 233.

The specifying unit 233 specifies a candidate route satisfying a predetermined condition among the generated candidate routes (step S308). The specifying unit 233 outputs candidate route related information indicating information related to the specified candidate route and candidate route information of the specified candidate route to the route information generation unit 234 in association with each other.

The route information generation unit 234 generates route information in a format capable of outputting a route indicated by a candidate route satisfying a predetermined condition according to a predetermined format, and outputs the generated route information to the transmission unit 25 (step S309).

The transmission unit 25 transmits the route information to a predetermined arbitrary communication destination (step S310).

As described above, the route generation device 2 of the present example embodiment acquires the departure location information indicating the departure location of the unmanned aerial vehicle and the destination location information indicating the destination location, and generates a plurality of candidate routes from the departure location to the destination location of the unmanned aerial vehicle. The route generation device 2 performs a process for outputting route information indicating a candidate route that satisfies a predetermined condition among a plurality of generated candidate routes. The route generation device 2 outputs route information in a format capable of outputting a route indicated by a candidate route satisfying a predetermined condition according to a predetermined format. The route generation device 2 can present the route corresponding to the request of the user operating the unmanned aerial vehicle in a format according to the predetermined format by outputting the route information in a format capable of outputting the route indicated by the candidate route satisfying the predetermined condition according to a predetermined format.

### First modified example of second example embodiment

An acquisition unit of a route generation device according to a first modified example of the second example embodiment acquires information indicating a candidate route selected by a user from a device (e.g., the processing device 3) that has received route information. The route generation device according to the present modified example transmits route information in a format capable of outputting a route indicated by a candidate route selected by a user according to a predetermined format to a submission destination. For example, the predetermined format is a format of a flight plan. Furthermore, the submission destination is, for example, a government office or a local government that requests the user to submit a flight plan, an association that grants permission and authorization for flight of an unmanned aerial vehicle, or the like. The route information submitted by the route generation device may be route information after being corrected according to the operation input of the user.

The route generation device of the first modified example outputs route information in a format that can be output according to a format of a flight plan which is requested by a government office, a local government, or other associations that grant permission and authorization for flight of an unmanned aerial vehicle, and transmits the route information selected by the user to a submission destination. Specifically, for example, the route information is transmitted to an electronic mail address designated in advance by the submission destination or an internet protocol (IP) address. More specifically, for example, the route generation device transmits route information to a flight plan acceptance system installed by the submission destination via an electronic communication line such as the Internet.

As a result, the user who operates the unmanned aerial vehicle can easily submit the flight plan of the route according to the request to the government office or the local government, in such a way that the burden on the user can be reduced.

### Second modified example of second example embodiment

A route generation device according to a second modified example of the second example embodiment acquires current position information indicating a current position of a flying unmanned aerial vehicle as departure location information. The acquisition unit of the route generation device of the present modified example may acquire by receiving the current position information indicating the current position, the departure date and time information indicating the current date and time, and the destination location information from the flying unmanned aerial vehicle. The route generation device of the present modified example generates a plurality of candidate routes from the current position to a destination location of an unmanned aerial vehicle.

In addition, the processing unit of the route generation device of the present modified example performs a process for transmitting the route information to the notification destination designated by the operator of the unmanned aerial vehicle.

The acquisition unit of the route generation device of the present modified example may acquire information for specifying the position of another unmanned aerial vehicle flying around the unmanned aerial vehicle from the flying unmanned aerial vehicle. For example, the acquisition unit may acquire image data photographed by an imaging device mounted on the unmanned aerial vehicle and information indicating a photographing direction with respect to a moving direction of the unmanned aerial vehicle. The route generation unit may calculate the relative position with respect to the flying unmanned aerial vehicle for another unmanned aerial vehicle photographed in the image indicated by the image data based on the image data and the information indicating the photographing direction with respect to the moving direction of the unmanned aerial vehicle. The route generation unit generates a candidate route including a route for avoiding another unmanned aerial vehicle flying around the unmanned aerial vehicle. As a result, the route generation device of the present modified example can reduce the possibility of the unmanned aerial vehicle colliding with another unmanned aerial vehicle more than before the route for avoiding the unmanned aerial vehicle flying around is generated.

In addition, when the route generation device is requested to generate the candidate route of each of the plurality of flying unmanned aerial vehicles at the same timing, the route generation unit of the route generation device generates the candidate route of each of the plurality of unmanned aerial vehicles in such a way as not to collide with another unmanned aerial vehicle.

When the flight plan is submitted in advance to a predetermined submission destination such as a government office or a local government, the route generation device may perform the following process. The acquisition unit acquires information indicating the candidate route selected by the user from the device that has received the route information. The processing unit transmits, via the transmission unit, route information in a format capable of outputting a route indicated by the candidate route selected by the user according to the format of the flight plan to the submission destination. Alternatively, the route generation device may notify the submission destination of the flight plan that the flight plan has been changed. In addition, the route generation device may include a control unit that controls the unmanned aerial vehicle. The control unit of the route generation device may control the unmanned aerial vehicle to fly along a flight path of a candidate route selected by the user.

### Third modified example of second example embodiment

The route generation device of the third modified example of the second example embodiment generates a candidate route from the current position to a destination location of a flying unmanned aerial vehicle. The route generation device of the third modified example is different from the route generation device of the second modified example of the second example embodiment in the following points. The route generation device of the third modified example of the second example embodiment generates a candidate route according to a current cruisable distance of the unmanned aerial vehicle.

In a case where the flying unmanned aerial vehicle is caught in traffic jam, the unmanned aerial vehicle stays in the air and waits for the traffic jam to resolve, and hence it is assumed that power is consumed more than expected before departure. When the power of the unmanned aerial vehicle is insufficient, the unmanned aerial vehicle may crash in the middle of the flight path. In addition to traffic jam, it is assumed that the cruisable distance becomes shorter than expected before departure due to a failure or an accident.

The acquisition unit of the route generation device of the present modified example acquires information used for calculating the cruisable distance of the unmanned aerial vehicle from the unmanned aerial vehicle or the control device of the unmanned aerial vehicle. When the cruisable distance is shorter than the distance from the current position to the destination location, an alarm is issued from the unmanned aerial vehicle. Information used for calculating the cruisable distance of the unmanned aerial vehicle may be transmitted from the unmanned aerial vehicle together with an alarm.

The information used to calculate the cruisable distance of the unmanned aerial vehicle is, for example, information indicating the current cruisable distance of the unmanned aerial vehicle. The information indicating the cruisable distance indicates a distance that the unmanned aerial vehicle can fly by the current charge amount from the current position of the unmanned aerial vehicle. That is, the information used to calculate the cruisable distance of the unmanned aerial vehicle may include information itself indicating the cruisable distance of the calculation target.

Alternatively, for example, the information used to calculate the cruisable distance of the unmanned aerial vehicle is information indicating the current charge amount of the unmanned aerial vehicle, a parameter indicating the weight of the loaded cargo, and a parameter related to the flying ability of the unmanned aerial vehicle. In a case where the parameter used to calculate the cruisable distance of the unmanned aerial vehicle is stored in the area information storage unit, the acquisition unit may acquire the parameter used to calculate the cruisable distance of the unmanned aerial vehicle by reading from the area information storage unit.

The route generation unit of the route generation device of the present modified example specifies the charging facility that can be reached from the current position of the unmanned aerial vehicle from the cruisable distance indicated by the information indicating the cruisable distance. The route generation unit may calculate the cruisable distance from information indicating the current charge amount of the unmanned aerial vehicle, a parameter indicating the weight of the loaded cargo, and a parameter related to the flying ability of the unmanned aerial vehicle. In a case where a plurality of charging facilities are specified, the route generation unit selects a charging facility located in the direction of the destination location indicated by the destination location information included in the information indicating the flight path in which the unmanned aerial vehicle is flying acquired by the acquisition unit from the current position.

The route generation unit generates a candidate route from the current position to the destination location using the specified or selected charging facility. Alternatively, the route generation unit may generate, as a candidate route, a route corresponding to the cruisable distance indicated by the information indicating the cruisable distance.

The route corresponding to the cruisable distance is, for example, a route to an emergency landing site other than the charging facility, which can be reached by the unmanned aerial vehicle from the current position. At the emergency landing site, a collecting service of the unmanned aerial vehicle may be provided. In a case where a collecting service of an unmanned aerial vehicle by a large unmanned aerial vehicle is provided, the route may be a route from a current position to a scheduled arrival point of the large unmanned aerial vehicle.

The acquisition unit may acquire information indicating whether the collecting service of the unmanned aerial vehicle is available. For example, it is assumed that an unmanned aerial vehicle that has insurance can use a collecting service of the unmanned aerial vehicle at a crash site or an emergency landing site. The acquisition unit acquires information indicating the insured status of insurance from the unmanned aerial vehicle or the control device of the unmanned aerial vehicle. In a case where the information indicating the insured status of the insurance indicates insured, the route generation unit generates, as candidate routes, a route from the current position to the destination location that uses the specified or selected charging facility and a route corresponding to the cruisable distance indicated by the information indicating the cruisable distance. When the information indicating the insured status of the insurance indicates uninsured, the unmanned aerial vehicle cannot use the collecting service, and thus the route generation unit generates a route from the current position to the destination location that uses the specified or selected charging facility as a candidate route.

The route generation device of the present modified example generates, as a candidate route, a route from a current position to a destination location that uses the charging facility based on a cruisable distance of the unmanned aerial vehicle. Alternatively, the route generation device of the present modified example may generate, as a candidate route, a route corresponding to the cruisable distance indicated by the information indicating the cruisable distance. By allowing the user who operates the unmanned aerial vehicle to grasp the candidate route generated by the route generation device, it is possible to reduce the possibility of the unmanned aerial vehicle crashing even when the cruisable distance becomes shorter than expected before departure.

The route generation device of the present modified example generates a candidate route according to a current cruisable distance of the unmanned aerial vehicle. Alternatively, the route generation device of the present modified example may generate, as a candidate route, a route corresponding to the cruisable distance indicated by the information indicating the cruisable distance. By allowing the user who operates the unmanned aerial vehicle to grasp the candidate route generated by the route generation device, it is possible to reduce the possibility of the unmanned aerial vehicle crashing while flying even when the cruisable distance becomes shorter than expected before departure.

### Fourth modified example of second example embodiment

A route generation device according to a fourth modified example of the second example embodiment is different from the route generation devices according to the first to third modified examples of the second example embodiment in being incorporated in an entrance management device (not illustrated) provided in an entrance section of a corridor.

The route generation device of the present modified example is incorporated in an entrance management device (not illustrated) provided in an entrance section of a corridor. The storage device of the entrance management device stores flight plan information of the unmanned aerial vehicle entering the corridor from the entrance section. The unmanned aerial vehicle approaching the entrance management device transmits the remote ID including the unmanned aerial vehicle ID of the own device and the charge amount information indicating the current charge amount to the entrance management device in association with each other.

When the entrance management device receives the remote ID and the charge amount information indicating the current charge amount, the acquisition unit of the route generation device acquires the flight plan information associated with the unmanned aerial vehicle ID included in the received remote ID from the storage device of the entrance management device. The acquisition unit outputs the acquired flight plan information to an estimation unit to be described later. The acquisition unit outputs charge amount information indicating a current charge amount to a determination unit to be described later.

The route generation device of the present modified example further includes an estimation unit and a determination unit. Based on the departure location information, the departure date and time information, the destination location information, and the arrival date and time information included in the flight plan information, the estimation unit estimates the charge amount required by the unmanned aerial vehicle when the unmanned aerial vehicle flies along the flight path indicated by the flight path information from the current position. In the case of estimating the charge amount, the estimation unit may further use a parameter related to the weather, a parameter related to the flying ability of the unmanned aerial vehicle, and a parameter indicating the weight of the cargo. The estimation unit outputs charge amount information indicating the estimated charge amount to the determination unit.

The charge amount information indicating a current charge amount is input from the acquisition unit to the determination unit. The charge amount information indicating a current charge amount is input from the acquisition unit to the determination unit. When the current charge amount is larger than the estimated charge amount, the determination unit determines that the unmanned aerial vehicle is sufficiently charged. When determined as sufficiently charged, the unmanned aerial vehicle ID of the unmanned aerial vehicle to be determined and the fact that the unmanned aerial vehicle is sufficiently charged are notified to the entrance management device.

When the current charge amount is equal to or less than the estimated charge amount, the determination unit determines that the unmanned aerial vehicle is not sufficiently charged. When determined as not sufficiently charged, the unmanned aerial vehicle ID of the unmanned aerial vehicle to be determined and the fact that the unmanned aerial vehicle is not sufficiently charged are notified to the entrance management device. The entrance management device notified that the unmanned aerial vehicle is not sufficiently charged prohibits the unmanned aerial vehicle having the notified unmanned aerial vehicle ID from entering the corridor. For example, in a case where the entrance management device is provided with a gate, the entrance management device opens the gate of the unmanned aerial vehicle that is sufficiently charged and permits the unmanned aerial vehicle to enter the corridor. On the other hand, the entrance management device prohibits entry into the corridor while keeping the gate of the unmanned aerial vehicle that is not sufficiently charged closed. In addition, the entrance management device may notify the administrator of the corridor and the operator of the unmanned aerial vehicle that the unmanned aerial vehicle that is not sufficiently charged is about to enter the corridor. Alternatively, when the route generation device determines that the unmanned aerial vehicle is not sufficiently charged, the entrance management device may request the operator of the unmanned aerial vehicle or the submission destination of the flight plan to reject the flight plan associated with the unmanned aerial vehicle ID of the unmanned aerial vehicle to be determined.

The determination unit may perform the following operation instead of notifying the entrance management device of the unmanned aerial vehicle ID of the unmanned aerial vehicle to be determined and the fact that the unmanned aerial vehicle is not sufficiently charged. The determination unit may request the route generation unit to generate a candidate route corresponding to the current cruisable distance of the unmanned aerial vehicle. In the case of generating a candidate route corresponding to the current cruisable distance of the unmanned aerial vehicle, the route generation unit generates a route from the current position to the destination location that uses the charging facility as a candidate route. Alternatively, the route generation unit may generate, as a candidate route, a route corresponding to the cruisable distance indicated by the information indicating the cruisable distance. Since the operation of the route generation unit in the case of generating a candidate route corresponding to the current cruisable distance of the unmanned aerial vehicle is the same as the operation described in the third modified example of the second example embodiment, the description thereof will be omitted.

A route generation device of the present modified example is incorporated in an entrance management device provided in an entrance section of a corridor, and determines whether an unmanned aerial vehicle is sufficiently charged. When determined as not sufficiently charged, the route generation device notifies the unmanned aerial vehicle ID of the unmanned aerial vehicle to be determined and the fact that the unmanned aerial vehicle is not sufficiently charged to the entrance management device. The entrance management device notified that the unmanned aerial vehicle is not sufficiently charged prohibits the unmanned aerial vehicle having the notified unmanned aerial vehicle ID from entering the corridor. As a result, the administrator of the corridor and the operator of the unmanned aerial vehicle can grasp that the charging is insufficient. In addition, since the unmanned aerial vehicle determined to be insufficiently charged cannot enter the corridor, it is possible to reduce the possibility that the unmanned aerial vehicle flying in the corridor will crash.

### Hardware configuration example

The procedure described in each of the above example embodiments can be achieved by a route generation program for causing an information processing device (computer) functioning as a route generation device to achieve functions as these devices. The information processing device executes the route generation method by the program. Hereinafter, a configuration example of hardware resources that implement each of the route generation devices (1, 2) in the above-described example embodiments of the present invention using one information processing device (computer) will be described. The route generation device may be achieved physically or functionally by using at least two information processing devices. The route generation device may be implemented as a dedicated device. Alternatively, only a part of the functions of the route generation device may be implemented using the information processing device.

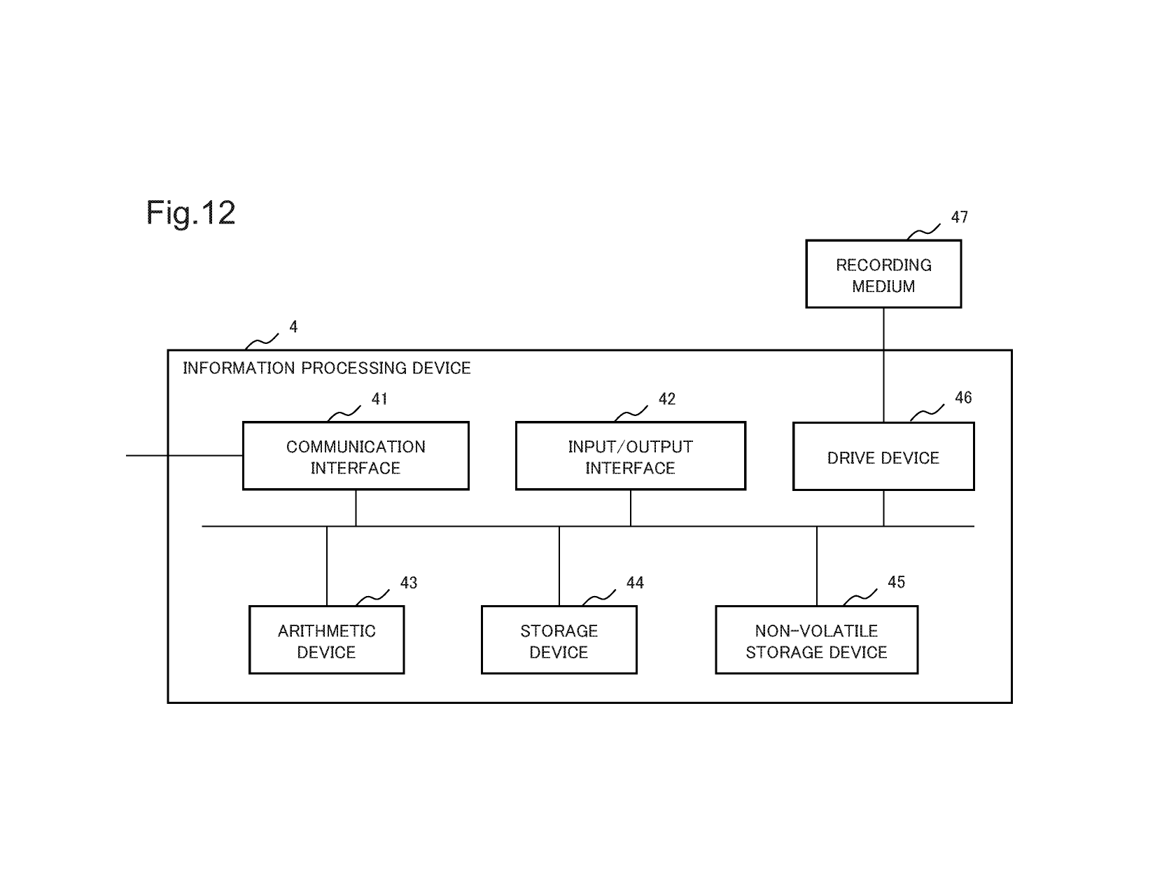

FIG. 12 is a diagram schematically illustrating a hardware configuration example of an information processing device capable of achieving the route generation device according to each example embodiment of the present invention. The information processing device 4 includes a communication interface 41, an input/output interface 42, an arithmetic device 43, a storage device 44, a non-volatile storage device 45, and a drive device 46.

For example, the acquisition unit 11 of the route generation device 1 in FIG. 1 can be achieved by the arithmetic device 43 and the communication interface 41. Each of the route generation unit 12 and the processing unit 13 of the route generation device 1 of FIG. 1 can be implemented by the arithmetic device 43.

The communication interface 41 is a communication means for the route generation device of each example embodiment to communicate with an external device in a wired or/and wireless manner. In a case where the route generation device is achieved by using at least two information processing devices, these devices may be connected in such a way as to be able to communicate with each other via the communication interface 41.

The input/output interface 42 is a man-machine interface such as a keyboard serving as an example of an input device or a display serving as an output device.

The arithmetic device 43 is achieved by a general-purpose central processing unit (CPU), an arithmetic processing device such as a microprocessor, or a plurality of electric circuits. For example, the arithmetic device 43 can read various programs stored in the non-volatile storage device 45 into the storage device 44 and execute processes according to the read program.

The storage device 44 is a memory device such as a random access memory (RAM) that can be referred to from the arithmetic device 43, and stores programs, various data, and the like. The storage device 44 may be a volatile memory device.

The non-volatile storage device 45 is a non-volatile storage device such as a read only memory (ROM) or a flash memory, and can store various programs, data, and the like.

The drive device 46 is, for example, a device that processes reading and writing of data on a recording medium 47 described later.

The recording medium 47 is an arbitrary recording medium capable of recording data, for example, an optical disk, a magneto-optical disk, a semiconductor flash memory, or the like.

In each example embodiment of the present invention, for example, the route generation device may be configured by the information processing device 4 illustrated in FIG. 12. Each example embodiment of the present invention may be implemented by supplying a program capable of implementing the functions described in each example embodiment with respect to the route generation device.

In this case, the example embodiment can be achieved by having the arithmetic device 43 execute the program supplied to the route generation device. In addition, not all but some of the functions of the route generation device can be configured by the information processing device 4.

Furthermore, the program may be recorded in the recording medium 47, and the route generation device may be configured such that the program is appropriately stored in the non-volatile storage device 45 at a shipment stage, an operation stage, or the like of the route generation device. In this case, as a method of supplying the program, a method of installing the program in the route generation device using an appropriate jig may be adopted in a manufacturing stage before shipment, an operation stage, or the like. In addition, as a method of supplying the program, a general procedure such as a method of downloading the program from the outside via a communication line such as the Internet may be adopted.

Each of the above-described example embodiments is a preferred example embodiment of the present invention, and various modifications can be made within a scope not deviating from the gist of the present invention.

Some or all of the above example embodiments may be described as the following supplementary notes, but are not limited to the following.

(Supplementary Note 1)

A route generation device comprising:
an acquisition means configured to acquire departure location information indicating a departure location and destination location information indicating a destination location of an unmanned aerial vehicle;
a route generation means configured to generate a plurality of candidate routes from the departure location to the destination location of the unmanned aerial vehicle; and
a processing means configured to perform processes for outputting route information indicating candidate routes that satisfy a predetermined condition among the plurality of generated candidate routes, wherein
the processing means outputs the route information in a format capable of outputting the route, which is indicated by the candidate routes satisfying the predetermined condition, according to a predetermined format.

(Supplementary Note 2)

The route generation device according to supplementary note 1, wherein
the route generation means is capable of generating a candidate route in which the unmanned aerial vehicle uses a charging facility, and
the processing means calculates a usage fee of the charging facility when the route generation means generates a candidate route that uses the charging facility, and outputs usage fee information indicating a calculation result.

(Supplementary Note 3)

The route generation device according to supplementary note 1 or 2, wherein
the acquisition means acquires departure date and time information indicating a departure date and time of the unmanned aerial vehicle, and
the processing means predicts a date and time of arrival at the destination location when the unmanned aerial vehicle departs at a date and time indicated by the departure date and time information and flies along a route indicated by the candidate route, and outputs arrival date and time information indicating a prediction result.

(Supplementary Note 4)

The route generation device according to any one of supplementary notes 1 to 3, wherein
the route generation means is capable of generating a candidate route on which the unmanned aerial vehicle passes through a toll section, and
the processing means calculates a toll of the toll section when the route generation means generates a candidate route that passes through the toll section, and outputs toll information indicating a calculation result.

(Supplementary Note 5)

The route generation device according to any one of supplementary notes 1 to 4, wherein
the route generation means predicts occurrence of traffic jam in the plurality of candidate routes based on a flight plan of another unmanned aerial vehicle, and generates a candidate route including a detour that bypasses the traffic jam when occurrence of the traffic jam is predicted, and
the processing means outputs the route information of the candidate route including the detour.

(Supplementary Note 6)

A route generation method comprising:
acquiring departure location information indicating a departure location and destination location information indicating a destination location of an unmanned aerial vehicle;
generating a plurality of candidate routes from the departure location to the destination location of the unmanned aerial vehicle;
performing processes for outputting route information indicating candidate routes that satisfy a predetermined condition among the plurality of generated candidate routes; and
outputting the route information in a format capable of outputting the route, which is indicated by the candidate routes satisfying the predetermined condition, according to a predetermined format.

(Supplementary Note 7)

The route generation method according to supplementary note 6, wherein
a candidate route on which the unmanned aerial vehicle uses a charging facility can be generated, and
a usage fee of the charging facility is calculated when a candidate route that uses the charging facility is generated, and usage fee information indicating a calculation result is output.

(Supplementary Note 8)

The route generation method according to supplementary note 6 or 7, further comprising:
acquiring departure date and time information indicating a departure date and time of the unmanned aerial vehicle; and
predicting a date and time of arrival at the destination location when the unmanned aerial vehicle departs at a date and time indicated by the departure date and time information and flies along a route indicated by the candidate route, and outputting arrival date and time information indicating a prediction result.

(Supplementary Note 9)

The route generation method according to any one of supplementary notes 6 to 8, wherein
a candidate route on which the unmanned aerial vehicle passes through a toll section can be generated, and
a toll of the toll section is calculated when a candidate route that passes through the toll section is generated, and toll information indicating a calculation result is output.

(Supplementary Note 10)

The route generation method according to any one of supplementary notes 6 to 9, further comprising:
predicting occurrence of traffic jam in the plurality of candidate routes based on a flight plan of another unmanned aerial vehicle, and generating a candidate route including a detour that bypasses the traffic jam when the occurrence of the traffic jam is predicted; and
outputting the route information of the candidate route including the detour.

(Supplementary Note 11)

A computer readable recording medium recorded with a route generation program for causing a computer to implement:
an acquisition function of acquiring departure location information indicating a departure location and destination location information indicating a destination location of an unmanned aerial vehicle;
a route generation function of generating a plurality of candidate routes from the departure location to the destination location of the unmanned aerial vehicle; and
a processing function of performing processes for outputting route information indicating candidate routes that satisfy a predetermined condition among the plurality of generated candidate routes, wherein
the processing function outputs the route information in a format capable of outputting the route, which is indicated by the candidate routes satisfying the predetermined condition, according to a predetermined format.

(Supplementary Note 12)

The computer readable recording medium recorded with the route generation program according to supplementary note 11, wherein
the route generation function is capable of generating a candidate route in which the unmanned aerial vehicle uses a charging facility, and
the processing function calculates a usage fee of the charging facility when the route generation function generates a candidate route that uses the charging facility, and outputs usage fee information indicating a calculation result.

(Supplementary Note 13)

The computer readable recording medium recorded with the route generation program according to supplementary note 11 or 12, wherein
the acquisition function acquires departure date and time information indicating a departure date and time of the unmanned aerial vehicle, and
the processing function predicts a date and time of arrival at the destination location when the unmanned aerial vehicle departs at a date and time indicated by the departure date and time information and flies along a route indicated by the candidate route, and outputs arrival date and time information indicating a prediction result.

(Supplementary Note 14)

The computer readable recording medium recorded with the route generation program according to any one of supplementary notes 11 to 13, wherein
the route generation function is capable of generating a candidate route on which the unmanned aerial vehicle passes through a toll section, and
the processing function calculates a toll of the toll section when the route generation function generates a candidate route that passes through the toll section, and outputs toll information indicating a calculation result.

(Supplementary Note 15)

A computer readable recording medium recorded with the route generation program according to any one of supplementary notes 11 to 14, wherein
the route generation function predicts occurrence of traffic jam in the plurality of candidate routes based on a flight plan of another unmanned aerial vehicle, and generates a candidate route including a detour that bypasses the traffic jam when occurrence of the traffic jam is predicted, and
the processing function outputs the route information of the candidate route including the detour.

Although the present invention has been described with reference to the example embodiments, the present invention is not limited to these example embodiments. Various changes that can be understood by those skilled in the art can be made to the configuration and details of the present invention within the scope of the present invention.

### Reference Signs List

1, 2 route generation device

11, 21 acquisition unit

12, 22 route generation unit

13, 23 processing unit

231 fee calculation unit

232 date and time prediction unit

233 specifying unit

234 route information generation unit

24 traffic jam prediction unit

25 transmission unit

26 area information storage unit

27 flight plan storage unit

3 processing device

31 input/output unit

32 transmission/reception unit

33 display control unit

4 information processing device

41 communication interface

42 input/output interface

43 arithmetic device

44 storage device

45 non-volatile storage device

46 drive device

47 recording medium

C1 to Cn toll section

E1 entrance section

O1 exit section

1. An unmanned aerial vehicle flight management system comprising:
a memory configured to store instructions; and
at least one processor configured to execute the instructions to perform:
acquiring departure location information indicating a departure location of an unmanned aerial vehicle and destination location information indicating a destination location of the unmanned aerial vehicle;
specifying a candidate route from among one or more candidate routes generated from the departure location to the destination location of the unmanned aerial vehicle;
outputting route information indicating the specified candidate route according to a predetermined format; and
controlling the unmanned aerial vehicle to fly along a flight path corresponding to the specified candidate route.

2. The unmanned aerial vehicle flight management system according to claim 1,
wherein the acquiring of the departure location information includes
acquiring current position information of a flying unmanned aerial vehicle as the departure location information.

3. The unmanned aerial vehicle flight management system according to claim 1,
wherein the one or more candidate routes are generated using at least one of:
a parameter related to weather;
a parameter related to flight ability of the unmanned aerial vehicle;
a parameter related to a flight plan of another unmanned aerial vehicle;
and a parameter related to cargo transported by the unmanned aerial vehicle.

4. The unmanned aerial vehicle flight management system according to claim 1,
wherein the one or more candidate routes include a plurality of candidate routes, and
wherein the at least one processor is further configured to execute the instructions to perform:
setting a predetermined condition based on setting information corresponding to an operation input of a user; and
specifying, from among the plurality of candidate routes, at least one candidate route that satisfies the predetermined condition.

5. The unmanned aerial vehicle flight management system according to claim 4,
wherein the predetermined condition includes at least one of:
a condition that an arrival time at the destination location is earliest;
a condition that a flight distance is shortest;
a condition that power consumption is lowest;
a condition related to a fee;
and a combination thereof.

6. The unmanned aerial vehicle flight management system according to claim 4,
wherein the outputting includes outputting route information of the at least one candidate route that satisfies the predetermined condition in a list format representing the at least one candidate route.

7. The unmanned aerial vehicle flight management system according to claim 6,
wherein the at least one processor is further configured to execute the instructions to perform:
outputting route information of a candidate route selected by the user from the list format in a format using a map.

8. The unmanned aerial vehicle flight management system according to claim 1,
wherein the at least one processor is further configured to execute the instructions to perform:
acquiring prohibited airspace information indicating a prohibited airspace; and
generating the one or more candidate routes such that the one or more candidate routes do not pass through the prohibited airspace.

9. The unmanned aerial vehicle flight management system according to claim 1,
wherein the at least one processor is further configured to execute the instructions to perform:
acquiring a flight plan of at least one other unmanned aerial vehicle;
predicting occurrence of congestion in an airspace based on the flight plan of the at least one other unmanned aerial vehicle; and
generating, as one of the one or more candidate routes, a candidate route including a detour route that avoids the airspace in which the congestion is predicted to occur.

10. The unmanned aerial vehicle flight management system according to claim 1,
wherein the at least one processor is further configured to execute the instructions to perform:
generating, as one of the one or more candidate routes, a candidate route in which the unmanned aerial vehicle uses a charging facility; and
calculating a usage fee of the charging facility.

11. The unmanned aerial vehicle flight management system according to claim 1,
wherein the at least one processor is further configured to execute the instructions to perform:
acquiring departure date and time information; and
predicting a date and time of arrival of the unmanned aerial vehicle at the destination location.

12. The unmanned aerial vehicle flight management system according to claim 1,
wherein the at least one processor is further configured to execute the instructions to perform:
transmitting route information based on the specified candidate route to a submission destination.

13. The unmanned aerial vehicle flight management system according to claim 2,
wherein the at least one processor is further configured to execute the instructions to perform:
acquiring range information indicating a remaining flight range of the unmanned aerial vehicle; and
generating, based on the range information, a candidate route from a current position indicated by the current position information to the destination location via a charging facility.

14. The unmanned aerial vehicle flight management system according to claim 1,
wherein the at least one processor is further configured to execute the instructions to perform:
acquiring information indicating an insurance enrollment status of the unmanned aerial vehicle; and
generating the one or more candidate routes from the departure location to the destination location based on the information indicating the insurance enrollment status of the unmanned aerial vehicle.

15. The unmanned aerial vehicle flight management system according to claim 1,
wherein the controlling includes transmitting, to the unmanned aerial vehicle or to a control unit associated with the unmanned aerial vehicle, control information for causing the unmanned aerial vehicle to fly along the flight path corresponding to the specified candidate route.

16. A method for managing flight of an unmanned aerial vehicle, the method comprising:
acquiring departure location information indicating a departure location of an unmanned aerial vehicle and destination location information indicating a destination location of the unmanned aerial vehicle;
specifying a candidate route from among one or more candidate routes generated from the departure location to the destination location of the unmanned aerial vehicle;
outputting route information indicating the specified candidate route according to a predetermined format; and
controlling the unmanned aerial vehicle to fly along a flight path corresponding to the specified candidate route.

17. The method according to claim 16,
wherein the one or more candidate routes include a plurality of candidate routes, and
wherein the method further comprises:
setting a predetermined condition based on setting information corresponding to an operation input of a user; and
specifying, from among the plurality of candidate routes, at least one candidate route that satisfies the predetermined condition.

18. A non-transitory computer-readable recording medium storing a program that causes a computer to execute:
acquiring departure location information indicating a departure location of an unmanned aerial vehicle and destination location information indicating a destination location of the unmanned aerial vehicle;
specifying a candidate route from among one or more candidate routes generated from the departure location to the destination location of the unmanned aerial vehicle;
outputting route information indicating the specified candidate route according to a predetermined format; and
controlling the unmanned aerial vehicle to fly along a flight path corresponding to the specified candidate route.

19. The non-transitory computer-readable recording medium according to claim 18,
wherein the controlling includes outputting control information for causing the unmanned aerial vehicle to fly along the flight path corresponding to the specified candidate route.
